(19) United States
(12) Patent Application Publication
(10) Pub. No.: US 2012/0062599 A1
(43) Pub. Date: Mar. 15, 2012

(54) PORTABLE TERMINAL

(75) Inventor: Satoshi MACHIDA, Kawasaki (JP)

(73) Assignee: FUJITSU TOSHIBA MOBILE COMMUNICATIONS LIMITED, Kawasaki-shi (JP)

(21) Appl. No.: 13/303,492

(22) Filed: Nov. 23, 2011

Related U.S. Application Data
(63) Continuation of application No. PCT/JP2009/059630, filed on May 26, 2009.

(51) Int. Cl. G09G 5/00

(52) U.S. Cl. 345/655

(57) ABSTRACT

A portable terminal includes a storage unit storing plural icons and plural icon display area images corresponding to the plural icons, a display unit displaying a predetermined number of target icon display area images among the plural icon display area images together with target icons corresponding to the target icon display area images, the target icon display area images being arranged in a first direction, an input unit receiving an instruction by detecting movement of a contact object contacting an operation surface of the display unit, and a control unit moving the target icon display area images in a second direction while rotating the target icon display area images around corresponding axes extending along the target icon display area images when the input unit detects the contact object being moved in a direction opposite to the first direction. The corresponding axes are substantially perpendicular to the second direction.

### CROSS-REFERENCE TO RELATED APPLICATIONS

This application is a U.S. continuation application filed under 35 USC 111(a) claiming benefit under 35 USC 120 and 365(c) of PCT application JP 2009/059630, filed May 26, 2009. The foregoing application is hereby incorporated herein by reference.

### FIELD

The embodiments discussed herein are related to a portable terminal including a pointing device such as a touch pad or a touch panel.

### BACKGROUND

Portable terminals such as mobile phones are equipped with various input devices for receiving maneuver instructions from the user. Among the various input devices, there is an input device such as a touch pad or a touch panel that enables the user to input maneuver instructions by transmitting some kind of intuitive movement to the input device. The touch pad and the touch panel are configured to receive maneuver instructions in accordance with input position data obtained from a touch sensor that detects changes (e.g., changes of electrostatic capacitance, changes of contact pressure) caused by contact upon a maneuver surface.

From the standpoint of reducing the size of the portable terminal, the area of the portable terminal's display for displaying images is limited. Due to the limited area of the display, images such as icons are to be displayed in small sizes for displaying large amount of information on the display.

In a case of the touch panel having a display device and an input device combined into a single body, instructions are input by pressing a finger or the like to plural icons displayed on the touch panel. It is necessary for the user to find a desired icon from the small icons displayed on the touch panel and touch the desired icon accurately.

### SUMMARY

According to an aspect of the invention, there is provided a portable terminal including a storage unit that stores plural icons and plural icon display area images corresponding to the plural icons, a display unit that displays a predetermined number of target icon display area images among the plural icon display area images together with target icons corresponding to the target icon display area images, the target icon display area images being arranged in a first direction, an input unit that receives an instruction by detecting movement of a contact object contacting an operation surface of the display unit, and a control unit that moves the target icon display area images in a second direction while rotating the target icon display area images around corresponding axes extending along the target icon display area images in a case where the input unit detects the contact object being moved in a direction opposite to the first direction, wherein the corresponding axes are substantially perpendicular to the second direction.

The object and advantages of the invention will be realized and attained by means of the elements and combinations particularly pointed out in the claims.

It is to be understood that both the foregoing generation description and the followed detailed description are exemplary and explanatory and are not restrictive of the invention, as claimed.

### BRIEF DESCRIPTION OF DRAWINGS

FIG. 1 is a schematic diagram illustrating a portable terminal according to an embodiment of the present invention;

FIG. 2 is a block diagram illustrating a function configuration of a portable terminal according to an embodiment of the present invention;

FIG. 3 is a schematic diagram illustrating an example of a main screen of a portable terminal according to an embodiment of the present invention;

FIG. 4 is a schematic diagram illustrating an example of a main screen of a portable terminal according to an embodiment of the present invention where gadget switch icons are displayed on the main screen;

FIG. 5 is a schematic diagram illustrating how the icon display area images are arranged according to an embodiment of the present invention;

FIGS. 6A-6E are schematic diagrams for describing an example of slide display of icon display area images according to an embodiment of the present invention;

FIG. 7 is a schematic diagram illustrating an example of a main screen displaying thumbnail icons in an expanded thumbnail display state according to an embodiment of the present invention;

FIG. 8 is a schematic diagram illustrating an example of a main screen displaying an enlarged thumbnail icon in a regular thumbnail display state according to an embodiment of the present invention;

FIG. 9 is a schematic diagram illustrating an example of a main screen displaying an enlarged thumbnail icon in an expanded thumbnail display state according to an embodiment of the present invention;

FIG. 10 is a flowchart for describing a gadget icon display operation performed by a main control unit of a portable terminal according to an embodiment of the present invention;

FIG. 11 is a schematic diagram for describing a user's maneuver performed during the gadget icon display operation of FIG. 10;

FIG. 12 is a flowchart for describing a gadget switch icon display operation performed by a main control unit of a portable terminal according to an embodiment of the present invention;

FIG. 13 is a schematic diagram for describing the user's maneuver performed during the gadget switch icon display operation of FIG. 12;

FIG. 14 is a flowchart for describing a gadget switch icon confirmation instruction reception operation performed by a main control unit of a portable terminal according to an embodiment of the present invention;

FIG. 15 is a schematic diagram for describing the user's maneuver performed during the gadget switch icon confirmation instruction reception operation of FIG. 14;

FIG. 16 is a flowchart for describing a gadget switch icon enlargement operation performed by a main control unit of the portable terminal according to an embodiment of the present invention;

FIG. 17 is a schematic diagram for describing the user's maneuver performed during the gadget switch icon enlargement operation of FIG. 16;

FIG. 18 is a schematic diagram for describing another user's maneuver performed during the gadget switch icon enlargement operation of FIG. 16;

FIG. 19 is a flowchart for describing a icon display area image slide display operation performed by a main control unit of a portable terminal according to an embodiment of the present invention;

FIG. 20 is a schematic diagram for describing the user's maneuver performed during the icon display area image slide display operation of FIG. 19;

FIG. 21 is a schematic diagram for describing a determination angle for determining the validity of a slide maneuver according to an embodiment of the present invention;

FIG. 22 is a flowchart for describing a launcher icon confirmation instruction reception operation performed by a main control unit of a portable terminal according to an embodiment of the present invention;

FIG. 23 is a schematic diagram for describing the user's maneuver performed during the launcher icon confirmation instruction reception operation of FIG. 22;

FIG. 24 is a flowchart for describing a thumbnail icon status control operation performed in a regular thumbnail display state by a main control unit of a portable terminal according to an embodiment of the present invention;

FIG. 25 is a schematic diagram for describing the user's maneuver performed during the thumbnail icon status control operation of FIG. 24;

FIG. 26 is a flowchart for describing a thumbnail icon status control operation performed in an expanded thumbnail display state by a main control unit of a portable terminal according to an embodiment of the present invention;

FIG. 27 is a schematic diagram for describing the user's maneuver performed during the thumbnail icon status control operation of FIG. 26;

FIG. 28 is a flowchart for describing a thumbnail icon confirmation icon confirmation instruction reception operation performed by a main control unit of a portable terminal according to an embodiment of the present invention;

FIG. 29 is a schematic diagram for describing the user's maneuver performed during the thumbnail icon confirmation instruction reception operation of FIG. 28;

FIG. 30 is a flowchart for describing a thumbnail icon enlargement operation performed in a regular thumbnail display state by a main control unit of a portable terminal according to an embodiment of the present invention;

FIG. 31 is a schematic diagram for describing the user's maneuver performed during the thumbnail icon enlargement operation of FIG. 30;

FIG. 32 is a flowchart for describing an operation performed by a main control unit of a portable terminal in a case where thumbnail icons are displayed in an enlarged state during a regular thumbnail display state according to an embodiment of the present invention;

FIG. 33 is a schematic diagram for describing the user's maneuver performed during the thumbnail icon enlargement operation of FIG. 32;

FIG. 34 is a flowchart for describing an operation performed by a main control unit of a portable terminal in a case where thumbnail icons are displayed in an enlarged state during an expanded thumbnail display state according to an embodiment of the present invention; and

FIG. 35 is a schematic diagram for describing the user's maneuver performed during the thumbnail icon enlargement operation of FIG. 34.

### DESCRIPTION OF EMBODIMENTS

Embodiments of the present invention are described with reference to the drawings. A portable terminal according to an embodiment of the present invention may be a card type portable terminal enabling the user to input an instruction of a maneuver (maneuver instruction).

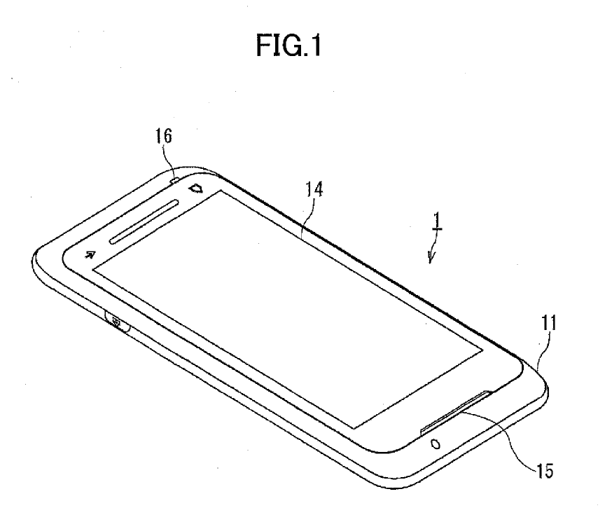

FIG. 1 is a schematic diagram illustrating a portable terminal 1 according to an embodiment of the present invention.

The portable terminal 1 has a planar rectangular casing 11. On one side of the casing 11, there is a touch panel 14 taking up a large portion of said side of the casing 11.

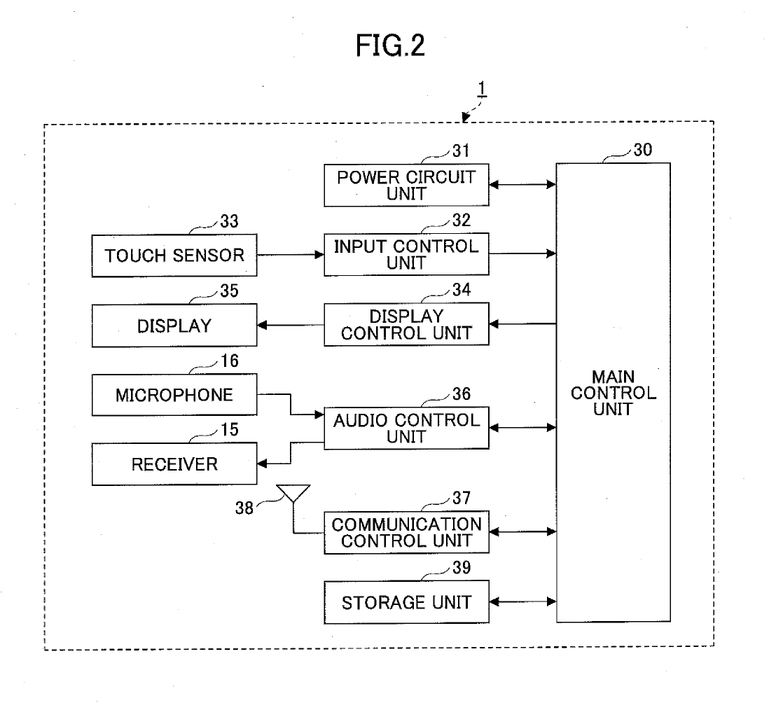

The touch panel 14 has a function of a display unit and a function of an input unit. The touch panel 14 includes a display (corresponding to display 35 in the below-described FIG. 2), plural elements provided on an upper surface of the touch panel 14 for detecting contact, and a transparent maneuver plane (corresponding to touch sensor 33 in the below-described FIG. 2) provided on top of the plural elements.

The touch panel 14 functioning as the display unit includes a display area that displays a display screen including texts and images. The display of the touch panel 14 may include, for example, LCD (Liquid Crystal Display), an organic EL (Electro-Luminescence) display, and an inorganic EL display.

The touch panel 14 functioning as the input unit receives an instruction by detecting movement of a contact object contacting a maneuver surface thereof. The contact object may include, for example, a finger of the user or a stylus pen. The method for detecting movement of the contact member may include, for example, a pressure detecting method that detects changes of pressure, an electrostatic detecting method that detects changes of electric signals of static electricity, or the like. The movement of the contact member is detected based on data of coordinates that indicate the position at which the contact member contacts. The data can be expressed with, for example, coordinate values of two axes in which one axis extends in the direction of the short side of the touch panel 14 and the other axis extends in the direction of the long side of the touch panel 14. In this embodiment, the contact object is described as being the finger of the user.

A receiver 15 for outputting sound (audio) and a microphone 16 for inputting audio are positioned at opposite sides in the longitudinal position of the casing 11.

FIG. 2 is a block diagram illustrating a function configuration of the portable terminal 1 according to an embodiment of the present invention. The portable terminal 1 includes, for example, a main control unit 30, a power circuit unit 31, an input control unit 32, a display control unit 34, an audio control unit 36, a communication control unit 37, and a storage unit 39 that are communicatively connected to each other by a bus.

The main control unit 30 includes a CPU (Central Processing Unit). The main control unit 30 performs overall control of parts and components of the portable terminal 1 (e.g., the input control unit 32, the display control unit 34) by operating in accordance with various programs stored in the storage part 39.

The power circuit unit 31 includes a power supply source (not illustrated). The power circuit unit 31 switches on/off the power supply of the portable terminal 1 in accordance with a power-on maneuver. In a state where the power supply is switched on, the power circuit unit 31 enables the portable terminal 1 to operate by supplying electric power from a power supply source to various parts of the portable terminal 1.

The input control unit 32 includes an input interface with respect to a touch sensor 33. The input control unit 32 receives a detection signal (including data indicating coordinates of an input position) from the touch sensor 33 at predetermined intervals and generates a signal indicating the data included in the detection signal to the main control unit 30.

The display control unit 34 includes a display interface with respect to a display 35. The display control unit 34 instructs the display 35 to display images based on text data and image signals in accordance with controls from the main control unit 30.

The audio control unit 36 generates analog audio signals from sounds gathered by the microphone 16 and converts the analog audio signal into digital audio signals in accordance with controls from the main control unit 30. Further, in a case where the audio control part 36 obtains digital audio signals, the audio control part 36 converts the digital audio signals into analog audio signals and outputs the analog signals (as sound) to the receiver 15 in accordance with controls from the main control unit 30.

The communication control unit 37 performs an inverse spread spectrum process on signals received from a base station via an antenna 38 and restores data included in the signals. In accordance with instructions from the main control unit 30, the restored data may be transmitted to the audio control unit 36 to be output from the receiver 15, transmitted to the display control unit 34 to be displayed by the display 35, or stored in the storage unit 39. Further, in a case where the communication control unit 37 obtains audio data gathered from the microphone 16, data input from the touch panel 14, data stored in the storage unit 39, the communication control unit 37 performs a spread spectrum process on the obtained data and transmits the processed data to the base station via the antenna 38.

The storage unit 39 includes, for example, a ROM (Read Only Memory) that stores data enabling the main control unit 30 to execute various programs and processes, a RAM (Random Access Memory) that temporarily stores data used by the main control unit, a hard disk, a non-volatile memory, a database and the like. In this embodiment, the storage unit 39 stores plural launcher icons and plural launcher icon display area images in correspondence with the plural launcher icons that are aligned in a predetermined order.

Next, an example of display control performed by the portable terminal 1 is described. In this embodiment, the portable terminal 1 particularly allows maneuvers to be intuitively performed on a main screen and provides excellent operability with the main screen. The below-described display control performed by the portable terminal 1 is not limited to the main screen of the portable terminal 1 but may also be applied to other screens of the portable terminal 1.

First, an example of maneuvers of the user (user maneuvers) performed on an operation plane of the touch panel 14 is described. The user maneuvers are detected as input instructions by the portable terminal 1.

The user maneuvers detected by the portable terminal 1 include, for example, a tap maneuver, a release maneuver, a short-push maneuver, a long-push maneuver, a slide maneuver, a flick maneuver, and a hold maneuver.

The tap maneuver is a maneuver detected when a finger of the user contacts an operation surface of the touch panel 14. The release maneuver is a maneuver detected when the user's finger contacting the operation surface by the tap maneuver is separated from the operation surface.

The short-push maneuver is a maneuver detected when the release maneuver is executed within a predetermined time after the tap maneuver. The long-push maneuver is a maneuver detected when the release maneuver is not detected after a predetermined time elapses after the tap maneuver. The time for determining whether a maneuver is the long-push maneuver is longer compared to the time for determining whether a maneuver is the short-push maneuver.

The slide maneuver is a maneuver detected when the user's finger is detected to move substantially in one direction at a predetermined speed or less in a state where the user's finger maintains contact to the operation surface of the touch panel 14. The flick maneuver is a maneuver detected when the finger is released (release maneuver) after the user's finger is detected to move substantially in one direction at a predetermined speed or less in a state where the user's finger maintains contact to the operation surface of the touch panel 14. The hold maneuver is detected when contact to the operation surface is maintained even after the long-push maneuver is detected. The hold maneuver does not need to have the finger positioned at a single position (immobile) but could be a maneuver in which the finger is moved on the operation screen.

Next, an example of a configuration and an operation of the main screen of the portable terminal 1 according to an embodiment of the present invention are described.

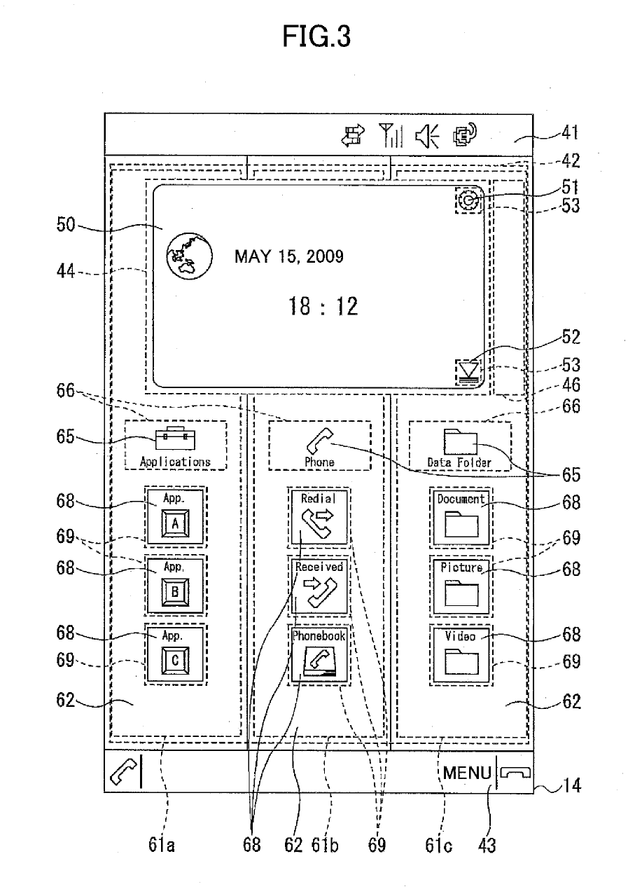

FIG. 3 is a schematic diagram illustrating an example of the main screen of the portable terminal 1 according to an embodiment of the present invention.

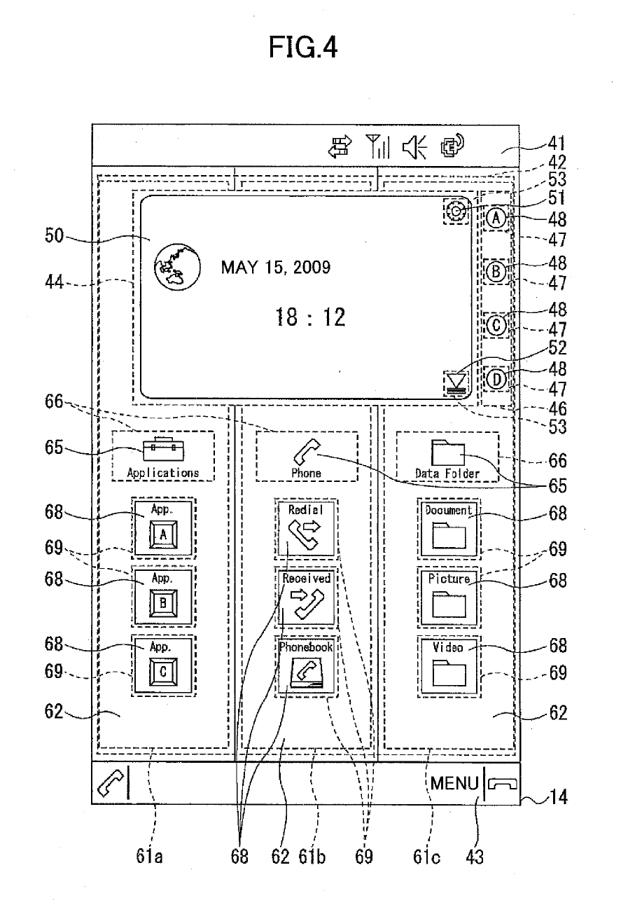

FIG. 4 is a schematic diagram illustrating an example of the main screen of the portable terminal 1 according to an embodiment of the present invention where gadget switch icons are displayed on the main screen.

The main screen of the portable terminal 1 includes, for example, an upper pict display area 41, a gadget icon area 42, and a lower pict display area 43.

One or more pict icons which indicate the current status of the portable terminal 1 are displayed in the upper pict display area 41. The pict icons displayed in the upper pict display area 41 may be, for example, a pict icon indicating the level of sensitivity of the antenna 38 or a pict icon indicating the connection status with respect to other devices. The lower pict display area 43 displays, for example, an icon for initiating or terminating an audio telephone call.

The gadget icon area 42 is positioned between the upper pict display area 41 and the lower pict display area 43. In this embodiment, the gadget icon area 42 mainly includes a gadget area 44, a launcher icon display area 61 (illustrated with reference numerals 61a, 6ab, and 61c in FIGS. 3 and 4), and a gadget switch icon display area 46.

In this embodiment, the gadget area 44 is mainly an area for displaying a gadget(s) stored in the portable terminal 1 on an upper portion of the touch panel 14 in FIGS. 3 and 4. The gadget 50 is small-sized accessory software that is operated on the main screen of the portable terminal 1. The gadget 50 includes a setting icon 51 and a display adjustment icon 52 to which instructions to the gadget 50 are input. The icons included in the gadget 50 are also referred to as “gadget icons”. The gadget icons are displayed inside a gadget icon area, respectively.

The setting icon 51 is for enabling various settings pertaining to the gadget 50 to be performed. The display adjustment icon 52 is for enabling adjustments pertaining to the gadget 20 to be performed.

Further, a gadget switch icon display area 46 is provided on the right side of the gadget area 44 as illustrated in FIG. 3.

The gadget switch icon display area 46 includes one or more gadget switch icon areas 47 (in this embodiment, four gadget switch icon areas) as illustrated in FIG. 4.

The gadget switch icon display area 46 is an area for displaying one or more gadget switch icons 48. The gadget switch icon 48 can be displayed by performing the tap maneuver on the main screen illustrated in FIG. 3.

The gadget switch icon 48 is used for discretionarily switching the gadget 50 displayed in the gadget area 44. The portable terminal 1 switches the gadget 50 displayed in the gadget area 44 when the portable terminal 1 receives an input instruction to the gadget switch icon 48 from the user.

Further, the gadget icon area 42 also includes the launcher icon display area 61 (hereinafter also simply referred to as “icon display area 61”). The icon display area 61 is transparently displayed through the gadget area 44 and the gadget switch icon display area 26. The launcher icon display area 61 includes, for example, a left launcher icon display area 61a, a center launcher icon display area 61b, and a right launcher icon display area 61c. In the following description, the left, center, and right icon display areas 61a, 61b, 61c may be collectively described as “icon display area 61” without distinguishing between right, center, and left. Although this embodiment has 3 icon display areas 61, there may be 3 or less icon display areas 61. Alternatively, 3 or more icon display areas may be provided.

The three icon display areas 61 are arranged in a stripe-like manner and extend in a vertical direction of the touch panel 14. A launcher icon display area image 62 (hereinafter simply referred to as “icon display area image”) is displayed in the icon display area 61. A launcher icon is displayed in correspondence with each launcher icon display area image 62. Further, a thumbnail icon 68 is displayed in the launcher icon display area image 62. The thumbnail icon 68 is an icon serving as a lower level icon with respect to a corresponding launcher icon (i.e. upper level icon) 65.

The number of icon display area images 62 retained (stored) in the portable terminal 1 corresponds to the number of corresponding launcher icons 65. In this embodiment, the portable terminal 1 retains (stores) 8 icon display area images 62 in which each icon display area image 62 corresponds to a single launcher icon 65. The icon display area images 62 are stored in the storage unit 39 in an order corresponding to the order in which the icon display area images 62 are displayed.

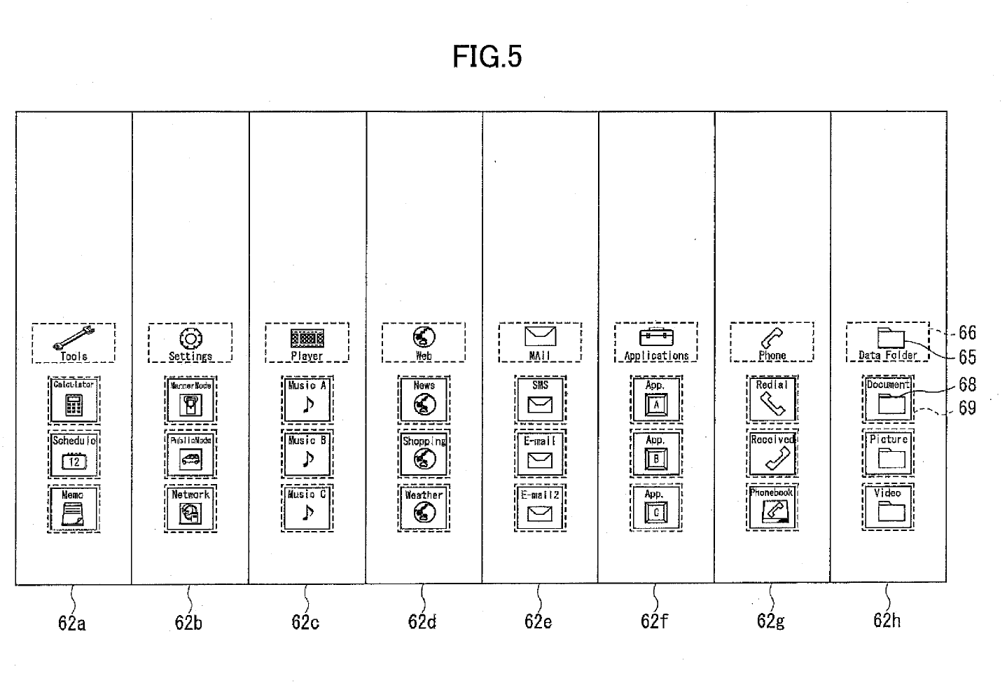

FIG. 5 is a schematic diagram illustrating how the icon display area images 62 are arranged according to an embodiment of the present invention. In this embodiment, icon display area images 62a, 62b, . . . 62g, 62h are arranged in a predetermined order in one direction (in FIG. 5, from left to right). It is to be noted that the icon display area images may also be simply referred to as “icon display area images 62” in a case where the icon display area images are not distinguished from each other.

The number of icon display area images 62 that can be displayed simultaneously on the main screen of the portable terminal 1 corresponds to the number of icon display areas 61 in the main screen of the portable terminal 1. In this embodiment, 3 icon display area images 62 can be displayed. That is, in this embodiment, 3 successively arranged icon display area images 62 are displayed simultaneously in the main screen of the portable terminal 1. Thus, in one example, the icon display area images 62a, 62b, and 62c are displayed. In another example, the icon display area images 62d, 62e, and 62f are displayed.

Therefore, the portable terminal 1 slidably displays the icon display area images 62 in order on the icon display areas 61 (slide display) by receiving the slide maneuver or the flick maneuver by the user. In this embodiment, the slide display can be performed only during the below-described regular thumbnail display status and not during the below-described expanded thumbnail display status.

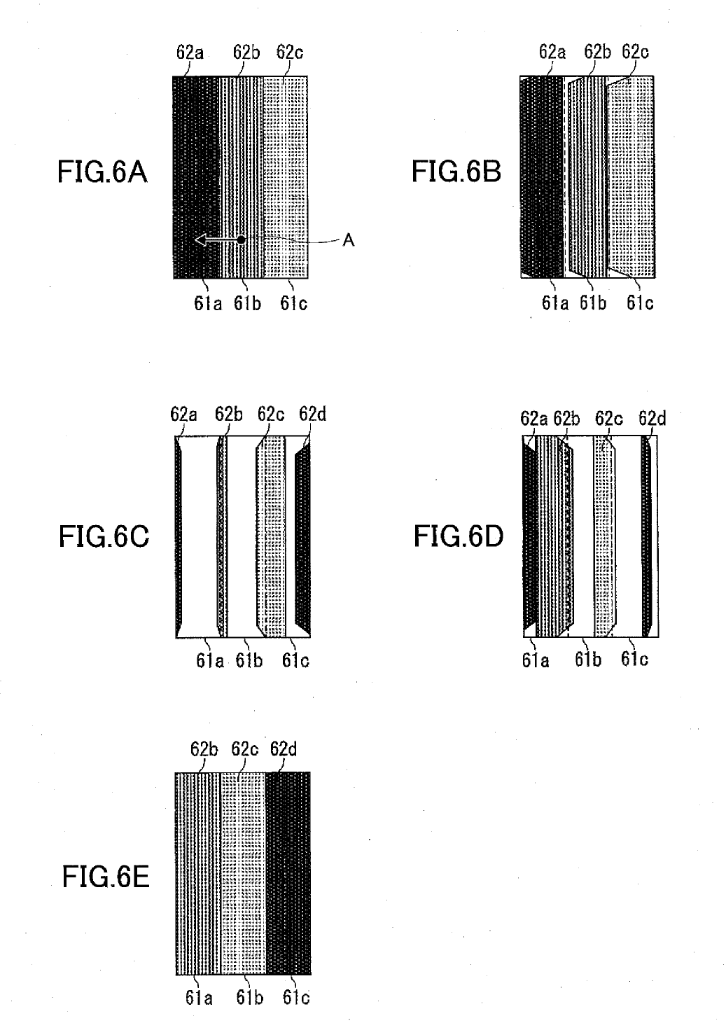

FIGS. 6A-6E are schematic diagrams for describing an example of the slide display of the icon display area images 62 according to an embodiment of the present invention.

For the sake of convenience, areas and icons except for the left icon display area 61a, the center icon display area 61b, the right icon display area 61c, and the icon display area images 62 (62a, 62b, 62c, 62d) are omitted in FIGS. 6A-6E.

In FIG. 6A, the icon display area images 62a-62c of FIG. 5 are displayed in the corresponding left icon display area 61a, the center icon display area 61b, and the right icon display area 61c.

With reference to FIG. 6A, the portable terminal 1 initiates the slide display when the portable terminal 1 detects a slide maneuver, for example, in the arrow direction (from right to left in FIG. 6A) in a state where the user's finger is contacting a position A of the operation surface on the icon display area image 62b. In this embodiment, the arrow direction of FIG. 6A is a direction corresponds to a forward direction in which the icon display area images 62 are arranged and slid.

In the slide display, the icon display area images 62 are displayed while being rotated around rotation axes extending along the corresponding icon display area images 62. The rotation axis is orthogonal and perpendicularly intersects the arrow direction (slide direction). Further, the portable terminal 1 also initiates the slide display when the portable terminal 1 detects a slide maneuver, for example, in a direction opposite to the arrow direction (from left to right in FIG. 6A) in a state where the user's finger is contacting the position A of the operation surface on the icon display area image 62b. Likewise, in the slide display, the icon display area images 62 are displayed while being rotated around rotation axes extending along the corresponding icon display area images 62. The rotation axis is orthogonal to and perpendicularly intersects the arrow direction (slide direction).

FIG. 6B illustrates a state where each of the icon display area images 62 is rotated approximately 15 degrees from the state illustrated in FIG. 6A and moved a predetermined distance in the slide direction. FIG. 6C illustrates a state where each of the icon display area images 62 is further rotated and moved from the state illustrated in FIG. 6B. In FIG. 6C, each of the icon display area images 62 is rotated approximately 80 degrees from the state illustrated in FIG. 6A.

FIG. 6D illustrates a state where each of the icon display area images 62 is further rotated and moved from the state illustrated in FIG. 6C. In FIG. 6D, each of the icon display area images 62 is rotated approximately 100 degrees from the state illustrated in FIG. 6A. In the state illustrated in FIG. 6D, the portable terminal 1 displays a side of each icon display area image 62 which is opposite to the side of the corresponding icon display area image 62 illustrated in FIGS. 6A-6D.

FIG. 6E illustrates a state where each of the icon display area images 62 is further rotated and moved from the state illustrated in FIG. 6D. In FIG. 6E, each of the icon display area images 62 is rotated approximately 180 degrees from the state illustrated in FIG. 6A. In addition to rotating approximately 180 degrees from the state illustrated in FIG. 6A, each of the icon display area images 62 of FIG. 6E is moved to an adjacent icon display area 61 in the arrow direction. In other words, the icon display area image 62a that was displayed in the icon display area 61a in FIG. 6A is no longer displayed in FIG. 6E. Further, the icon display area image 62b that was displayed in the icon display area 61b in FIG. 6A is displayed in the icon display area 61a in FIG. 6E. Further, the icon display area image 62c that was displayed in the icon display area 61c in FIG. 6A is displayed in the icon display area 61b in FIG. 6E. Further, the icon display area image 62d that was not displayed in FIG. 6A is displayed in the icon display area 61c in FIG. 6E.

As illustrated in FIGS. 6A-6E, the portable terminal 1 performs the slide display by rotating the icon display area images 62 while moving the icon display area images 62 to adjacent icon display areas 61. Further, after the portable terminal 1 performs the slide display in accordance with an instruction to perform the slide display, for example, to an icon display area image 62 arranged on one end of the icon display areas 61 (e.g., icon display area image 62a or icon display area image 62h in FIG. 5), the slide display cannot be performed any further in the forward direction. In this case, the slide display can only be performed in a direction opposite to the forward direction. For example, in a state where the icon display area image 62a of FIG. 5 is displayed by the slide display in the forward direction, the slide display is performed only in a case where the slide display is instructed to be performed toward the icon display area image 62h.

Further, until each of the icon display area images 62 is rotated approximately 90 degrees by slide display, the portable terminal 1 continues to display the launcher icon 65 and the thumbnail icon 68 illustrated on a first side displayed prior to the slide display. However, after each of the icon display area images 62 is rotated beyond approximately 90 degrees by the slide display, the launcher icon 65 and the thumbnail icon 68 are illustrated on a second side that is opposite to the first side.

In a case where the portable terminal 1 receives the slide maneuver, the portable terminal 1 performs the slide display in a manner that the icon display area images 62 are moved in correspondence with the movement of the finger placed on the operation surface. In a case where the portable terminal 1 receives the flick maneuver, the portable terminal 1 performs the slide display in a manner that, for example, 1 to 5 icon display area images 62 are displayed depending on the distance in which the user's finger is moved on the operation surface by the flick maneuver.

As illustrated in FIGS. 3 and 4, the launcher icon area 66 and the thumbnail icon area 69 are positioned below the gadget area 44. Further, the launcher icon area 66 and the thumbnail icon area 69 are successively arranged in a vertical direction (longitudinal direction) of the icon display area image 62.

The launcher icon 65 is displayed in the launcher icon area 66. The launcher icon 65 is an icon to be used as a launcher. In this embodiment, a launcher is a function that enables various functions of the portable terminal 1 to be activated in response to a simple input of an instruction to the launcher icon 65.

As for the launchers assigned to the launcher icon 65, there are, for example, an application launcher for activating a menu screen for activating various applications, and a setting launcher for activating a setting menu screen for performing various setting regarding the portable terminal 1. Furthermore, a dynamic image reproduction launcher for activating a dynamic image reproduction application, a web browser launcher used for activating a web browser, and a mail launcher used for activating e-mail and SMS (Short Message Service) applications may also be assigned to the launcher icon 65. Moreover, a telephone launcher for displaying telephone related functions and a data launcher for referring to folders storing data or various data stored in the portable terminal 1 may also be assigned to the launcher icon 65.

Further, the thumbnail icon area 69 is provided in the launcher icon area 66. The thumbnail icon 68 is a lower level icon provided below the launcher icon 65. The thumbnail icon 65 is displayed as a miniaturized image for displaying or listing, for example, an application(s) provided at a level below the launcher icon 65, data, and folders.

The thumbnail icon 68 is a thumbnail image of data used by an application activated by using, for example, the launcher icon 65. More specifically, the thumbnail icon 68 may be, for example, a thumbnail image of an image which can be displayed with the motion image reproduction application or a thumbnail image of data or a folder which can be browsed with the data launcher. The thumbnail icon 68 may also be, for example, a thumbnail image of a pre-registered web page which can be browsed with a web browser activated by the web browser launcher. Further, the thumbnail icon 68 may also be a thumbnail image displaying, for example, a function provided at a level below the launcher icon 65. More specifically, the thumbnail icon 68 may display the contents of settings (e.g., setting of volume, setting of manner-mode, setting of a network) performed with a setting menu screen activated by the setting launcher. It is to be noted that the thumbnail icon 68 does not need to be a thumbnail image but simply a lower level icon provided at a level below the launcher icon 65.

The portable terminal 1 displays the thumbnail icons 68 in two states. One state is a regular thumbnail display state and the other state is an expanded thumbnail display state.

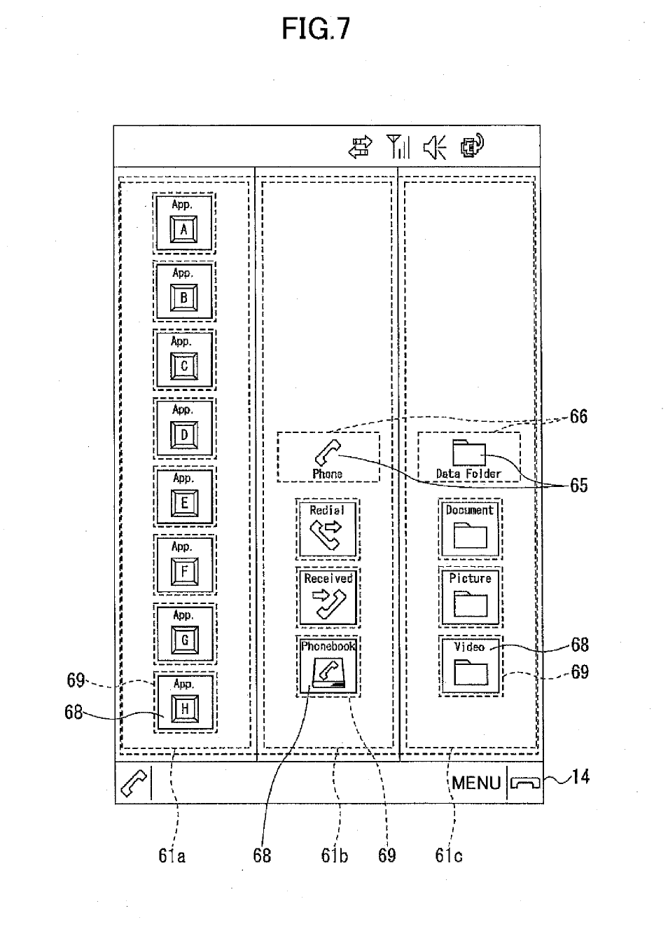

FIG. 7 illustrates an example of a main screen displaying the thumbnail icons 68 in the expanded thumbnail display state according to an embodiment of the present invention.

As illustrated in FIGS. 3 and 4, the “regular thumbnail display state” is a state where a first predetermined number of thumbnail icons 68 are displayed. The first predetermined number is stored as a first number in the storage unit 39. In a case of displaying the thumbnail icons 68 in the regular thumbnail display state, the portable terminal 1 displays, for example, thumbnail icons 68 which are discretionarily set by the user or thumbnail icons 68 which are frequently used by the user. In this embodiment, 3 thumbnail icons 68 are displayed in the regular thumbnail display state. Thus, in this embodiment, the first number stored in the storage unit 39 is 3.

As illustrated in FIG. 7, the “expanded thumbnail display state” is a state where a second predetermined number of thumbnail icons 68 are displayed. The second predetermined number is stored as a second number in the storage unit 39. In a case of displaying the thumbnail icons 68 in the expanded thumbnail display state, the portable terminal 1 displays the thumbnail icons 68 including the thumbnail icons 68 which are not displayed in the regular thumbnail display state by expanding the thumbnail icon area 69. In this embodiment, only a single icon display area 61 is displayed being in the expanded thumbnail display state. Nevertheless, the more than one single icon display area 61 may be displayed being in the expanded thumbnail display state.

The second number stored in the storage unit 39 may be the number of all of the thumbnail icons 68 stored in the storage unit 39. Alternatively, the second number 39 may be a number less than the number of all of the thumbnail icons 68. In this embodiment, 8 thumbnail icons 68 are displayed in the expanded thumbnail display state. Thus, in this embodiment, the second number stored in the storage unit 39 is 8.

With reference to FIGS. 3 and 4, in a case where the portable terminal 1 detects a slide maneuver in an upward direction on the icon display area 61 (e.g., icon display area 61a in FIGS. 3 and 4), the portable terminal 1, as a rule, shifts the displaying of the thumbnail icons 68 from the regular thumbnail display state to the expanded thumbnail display state. Further, with reference to FIG. 7, in a case where the portable terminal 1 detects, for example, a slide maneuver or a tap maneuver on the icon display area 61 (e.g., icon display area 61a in FIG. 7), the portable terminal 1, as a rule, shifts the displaying of the thumbnail icons 68 from the expanded thumbnail display state to the regular thumbnail display state.

In a case where the thumbnail icons 68 are displayed in the regular thumbnail display state or the expanded thumbnail display state, the portable terminal 1 can enlarge the thumbnail icons 68 (thumbnail icon areas 69).

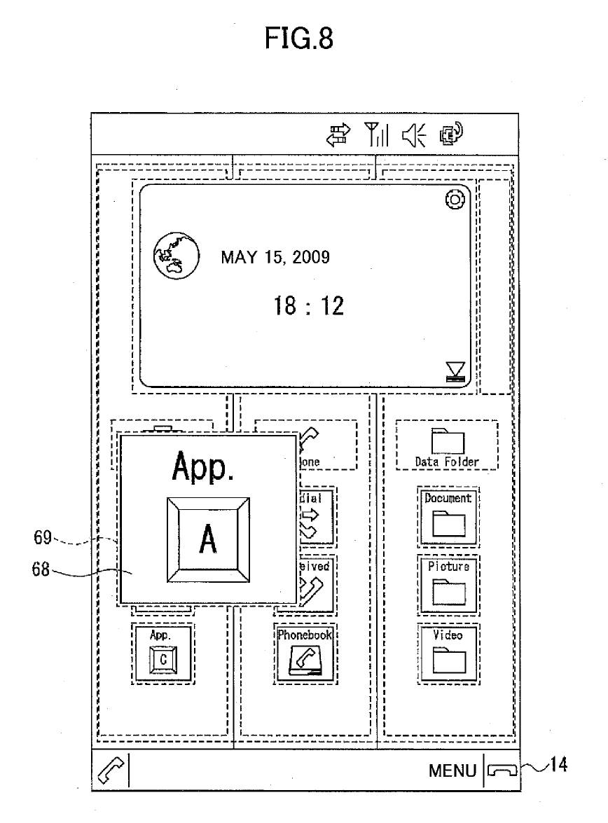

FIG. 8 illustrates an example of a main screen displaying an enlarged thumbnail icon 68 in the regular thumbnail display state according to an embodiment of the present invention.

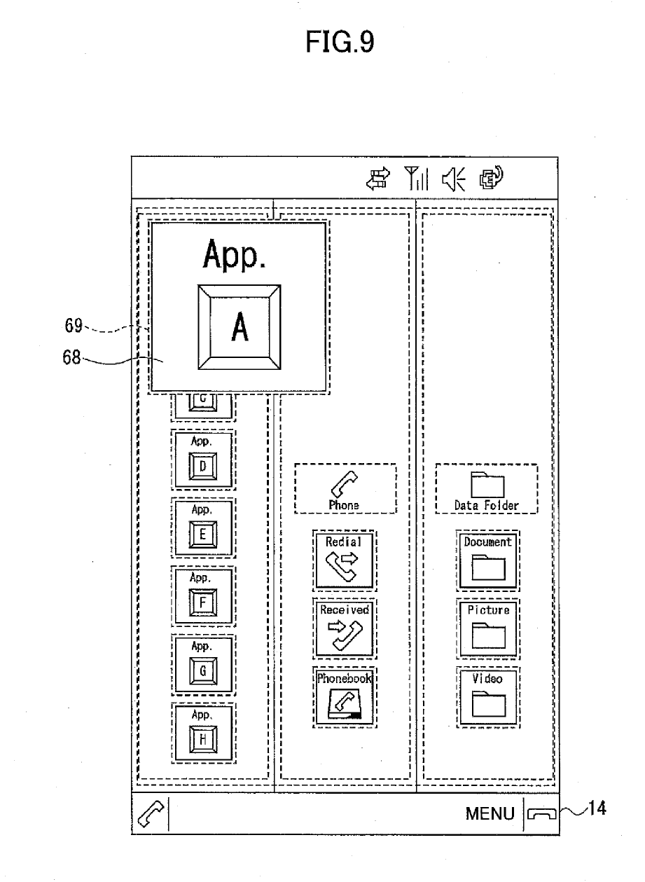

FIG. 9 illustrates an example of a main screen displaying an enlarged thumbnail icon 68 in the expanded thumbnail display state according to an embodiment of the present invention.

When a long-push maneuver is performed on one of the thumbnail icons 68 in the regular thumbnail display state or the expanded thumbnail display state, the portable terminal 1 displays the thumbnail icon 68 subjected to the long-push maneuver in a predetermined enlarged size. The portable terminal 1 continues to display the thumbnail icon 68 in the enlarged state as long as the long-push maneuver on the thumbnail icon 68 is continued.

Although not illustrated in the drawings, the portable terminal 1 displays the gadget icons (e.g., setting icon 51) and the gadget switch icon 48 in an enlarged size in a manner similar to the enlarged display of the thumbnail icons 68 according to the long-push maneuver.

Next, various processes and operations performed by the portable terminal 1 in the state where the main screen is displayed are explained with reference to the below-described flowcharts.

First, an operation of the portable terminal 1 is described in a case where the portable terminal 1 receives input to a gadget icon (in this embodiment, the setting icon 51) displayed on the gadget 50 according to an embodiment of the present invention. Although this embodiment describes an operation of the portable terminal 1 where the setting icon 51 receives input from the user, the operation of the portable terminal 1 may also be performed in a case where another icon displayed on the gadget receives input from the user.

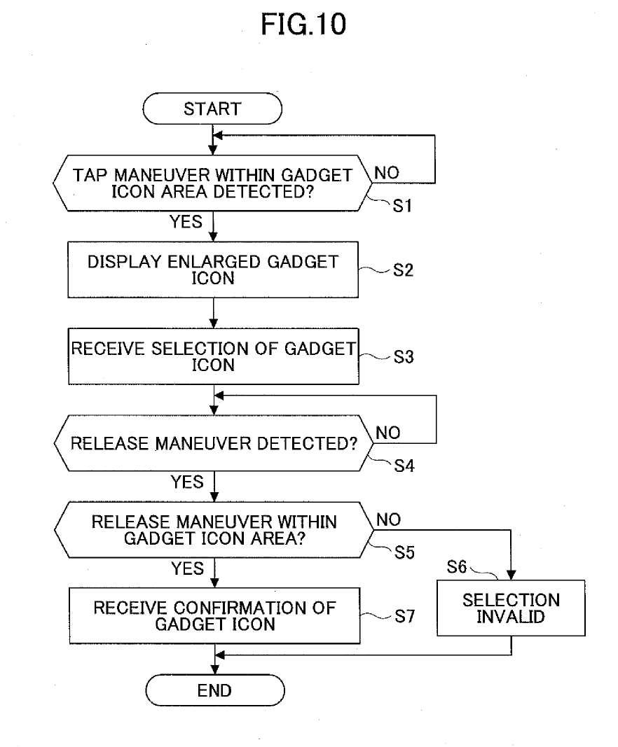

FIG. 10 is a flowchart for describing a gadget icon display operation performed by the main control unit 30 of the portable terminal 1 according to an embodiment of the present invention.

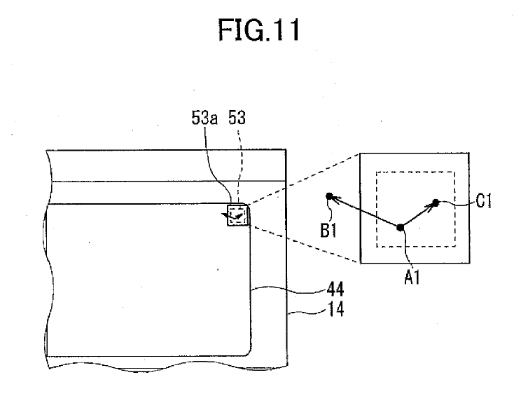

FIG. 11 is a schematic diagram for describing a user's maneuver performed during the gadget icon display operation of FIG. 10. For the sake of convenience, only a gadget icon area 53 is illustrated in FIG. 11 and the setting icon 51 is omitted from FIG. 11.

In Step S1, the main control unit 30 determines whether a tap maneuver is detected in the gadget icon area 53 displaying the setting icon 51 by referring to a signal indicating input received by the input control unit 32. For example, as illustrated in FIG. 11, the main control unit 30 determines whether a tap maneuver is detected at point A1 in the gadget icon area 53. In a case where the main control unit 30 determines that no tap maneuver is detected in the gadget icon area 53, the main control unit 30 waits (stands by) until detection of the tap maneuver.

On the other hand, in a case where the main control unit 30 determines that the tap maneuver is detected in the gadget icon area 53, the main control unit 30 enlarges the setting icon 51 displayed in the gadget icon area 53 in Step S2. More specifically, in this embodiment, the main control unit 30 enlarges the gadget icon area 53 and enlarges the setting icon 51 displayed in the gadget icon area 53. The main control unit 30 enlarges the setting icon 51 for the purpose of, for example, facilitating visibility for the user. For example, as illustrated in FIG. 11, the main control unit 30 enlarges the size of the gadget icon area 53 to the size of a gadget icon area 53a and enlarges the gadget icon 51 in correspondence with the enlarged gadget icon area 53a.

In Step S3, the main control unit 30 receives an instruction to select the setting icon 51 (selection instruction) in accordance with the tap maneuver.

The selection instruction is an instruction which is instructed prior to execution of a predetermined process associated to an icon (in this embodiment, the setting icon 51). Accordingly, the main control unit 30 executes the predetermined process associated to the icon when a confirmation instruction corresponding to the setting icon is received subsequent to receiving the selection instruction. For example, the main control unit 30 performs various settings regarding a gadget when a confirmation instruction corresponding to the setting icon 51 is received. Upon receiving the selection instruction, the main control unit 30 may change the manner of displaying the selected setting icon 51 or the gadget icon area 53 including the selected setting icon 51 for allowing the user to recognize that the selection instruction has been received. For example, the main control unit 30 may change the color of the setting icon 51 or the color of the gadget icon area 53 displaying the setting icon 51 therein. The term “selection instruction” and the term “confirmation instruction” also applied to other selected icons.

Then, the main control unit 30 determines whether a release maneuver is detected in Step S4. In a case where the main control unit 30 determines that no release maneuver is detected, the main control unit 30 waits (stands by) until detection of the release maneuver.

On the other hand, in a case where the main control unit 30 determines that the release maneuver is detected (Yes in Step S4), the main control unit 30 determines whether the position of the operation surface on which the release maneuver is performed is within the enlarged gadget icon area 53a. In a case where the release maneuver is detected outside the enlarged gadget icon area 53a (No in Step S5), the main control unit 30 invalidates the selection instruction received in Step S3 in Step S6. For example, with reference to FIG. 11, in a case where the release maneuver is received at point B1 located outside the gadget icon area 53a, the main control unit 30 invalidates the selection instruction.

On the other hand, in a case where the release maneuver is detected within the enlarged gadget icon area 53a (Yes in Step S5), the main control unit 30 receives a confirmation instruction in Step S7. In this embodiment, the confirmation instruction instructs that a predetermined setting process associated to the setting icon 51 be executed. For example, with reference to FIG. 11, the confirmation instruction is received when the main control unit 30 detects that the release maneuver is received at point C1 located within the gadget icon area 53a.

Next, an operation for displaying the gadget switch icon 48 (gadget switch icon display operation) according to an embodiment of the present invention is described.

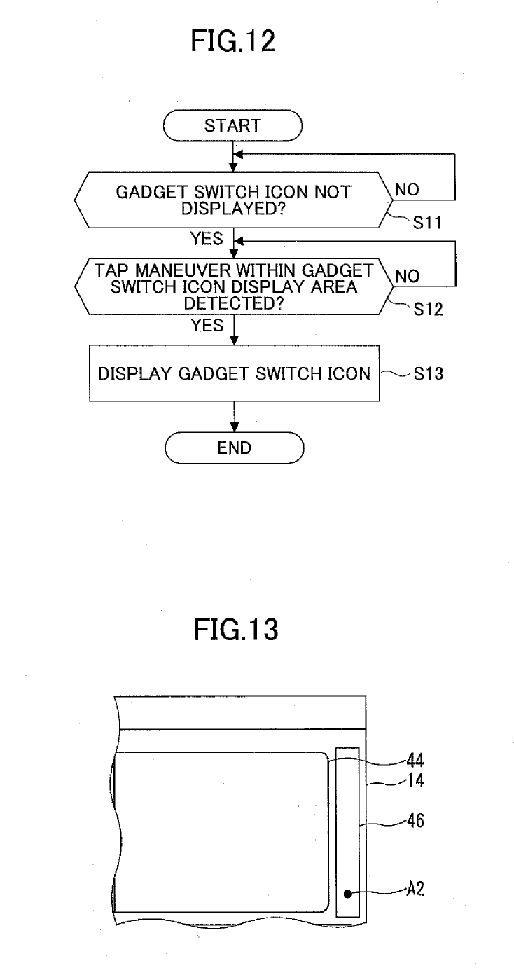

FIG. 12 is a flowchart for describing the gadget switch icon display operation performed by the main control unit 30 of the portable terminal 1 according to an embodiment of the present invention.

FIG. 13 is a schematic diagram for describing the user's maneuver performed during the gadget switch icon display operation of FIG. 12. For the sake of convenience, only a gadget switch icon display area 46 is illustrated in FIG. 12, and the gadget switch icon 48 is omitted from FIG. 12.

In Step S11, the main control unit 30 determines whether the gadget switch icon 48 is in a non-displayed state (see, for example, FIG. 3). In a case where the main control unit 30 determines that the gadget switch icon 48 is in a displayed state (No in Step S11), the main control unit 30 waits (stands by) until the gadget switch icon 48 becomes a non-displayed state.

On the other hand, in a case where the main control unit 30 determines that the gadget switch icon 48 is in a non-displayed state (Yes in Step S11), the main control unit 30 determines whether a tap maneuver is detected within the gadget switch icon display area 46 by referring to a signal indicating input received by the input control unit 32 in Step S12. For example, with reference to FIG. 13, the main control unit 30 determines whether a tap maneuver is detected at point A2 located within the gadget switch icon display area 46. In a case where the main control unit 30 determines that no tap maneuver is detected within the gadget switch icon display area 46 (No in Step S12), the main control unit 30 waits until detection of a tap maneuver within the gadget switch icon display area 46.

On the other hand, in a case where the main control unit 30 determines that a tap maneuver is detected within the gadget switch icon display area 46 (Yes in Step S12), the main control unit 30 provides a gadget switch icon area 47 and displays the gadget switch icon 48 in the gadget switch icon area 47 in Step S13 (see, for example, FIG. 4).

Next, an operation performed in a case where the gadget switch icon 48 receives input (gadget switch icon confirmation instruction receive operation) according to an embodiment of the present invention is described.

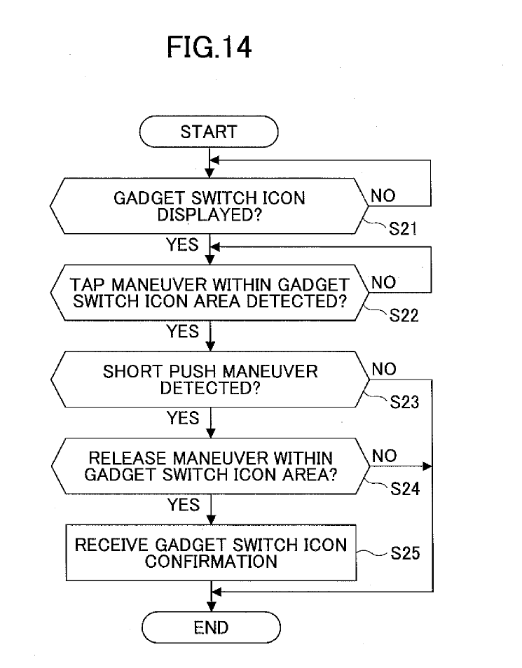

FIG. 14 is a flowchart for describing the gadget switch icon confirmation instruction reception operation performed by the main control unit 30 of the portable terminal 1 according to an embodiment of the present invention.

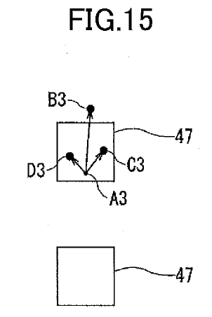

FIG. 15 is a schematic diagram for describing the user's maneuver performed during the gadget switch icon confirmation instruction reception operation of FIG. 14. For the sake of convenience, only the gadget switch icon area 47 is illustrated in FIG. 15, and the gadget switch icon 48 is omitted from FIG. 15.

In Step S21, the main control unit 30 determines whether the gadget switch icon 48 is displayed (see, for example, FIG. 4). In a case where the main control unit 30 determines that the gadget switch icon 48 is in a non-displayed state (see, for example, FIG. 3), the main control unit 30 waits until the gadget switch icon 48 is displayed.

On the other hand, in a case where the main control unit 30 determines that the gadget switch icon 48 is in a displayed state, the main control unit 30 determines whether a tap maneuver is detected within the gadget switch icon area 47 by referring to a signal indicating input received by the input control unit 32 in Step S22. For example, with reference to FIG. 15, the main control unit 30 determines whether a tap maneuver is detected at point A3 located within the gadget switch icon area 47. In a case where the main control unit 30 determines that no tap maneuver is detected within the gadget switch icon area 47 (No in Step S22), the main control unit 30 waits until detection of a tap maneuver within the gadget switch icon area 47.

On the other hand, in a case where the main control unit 30 determines that a tap maneuver is detected within the gadget switch icon area 47 (Yes in Step S22), the main control unit 30 determines whether a short-push maneuver is detected in Step S23. That is, the main control unit 30 determines whether a release maneuver is detected within a predetermined time after the detection of the tap maneuver. In a case where the main control unit 30 determines that the short-push maneuver is not detected (No in Step S23), the gadget switch icon confirmation instruction reception operation is terminated.

On the other hand, in a case where the main control unit 30 determines that the short-push maneuver is detected, the main control unit 30 determines whether the position of the operation surface on which a release maneuver (accompanying the short-push maneuver) is performed is within the gadget switch icon area 47 in Step S24. In a case where the release maneuver is received outside the gadget switch icon area 47 (No in Step S24), the main control unit 30 terminates the gadget switch icon confirmation instruction reception operation. For example, with reference to FIG. 15, in a case where the release maneuver is detected at point B3 located outside of the gadget switch icon area 47, the main control unit 30 does not receive any confirmation instruction with respect to the gadget switch icon 48.

On the other hand, in a case where the release maneuver is received within the gadget switch icon area 47 (Yes in Step S24), the main control unit 30 receives a confirmation instruction with respect to the gadget switch icon 48 in Step S25. For example, with reference to FIG. 15, the main control unit 30 receives a confirmation instruction when the release maneuver is received at point C3 or point D3 located within the gadget switch icon area 47. When the confirmation instruction is received, the main control unit 30 switches the gadget displayed in the gadget area 44 in accordance with the gadget switch icon 48 corresponding to the confirmation instruction.

Next, an operation performed in a case of displaying an enlarged gadget switch icon 48 (gadget switch icon enlargement operation) according to an embodiment of the present invention is described.

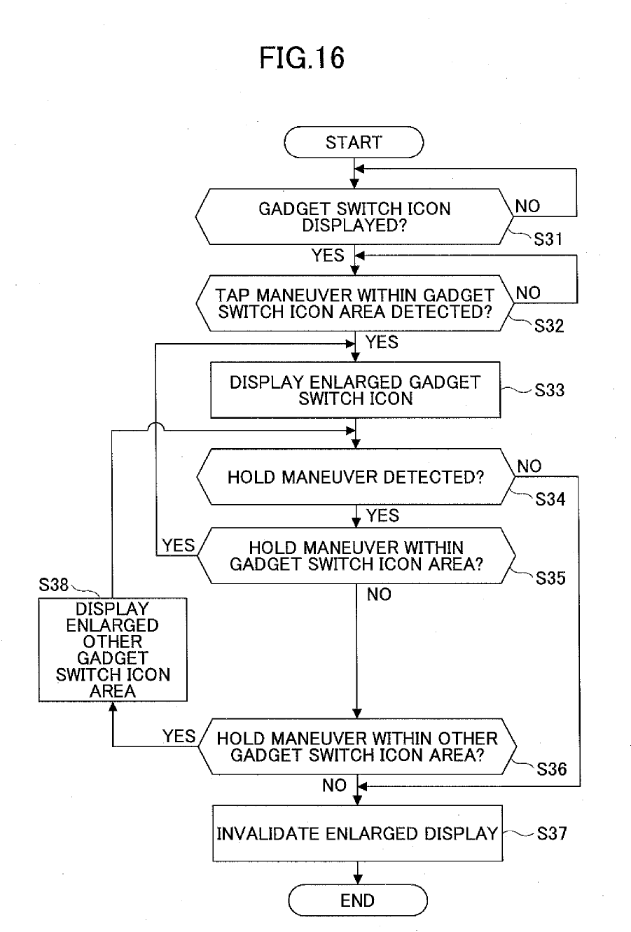

FIG. 16 is a flowchart for describing the gadget switch icon enlargement operation performed by the main control unit 30 of the portable terminal 1 according to an embodiment of the present invention.

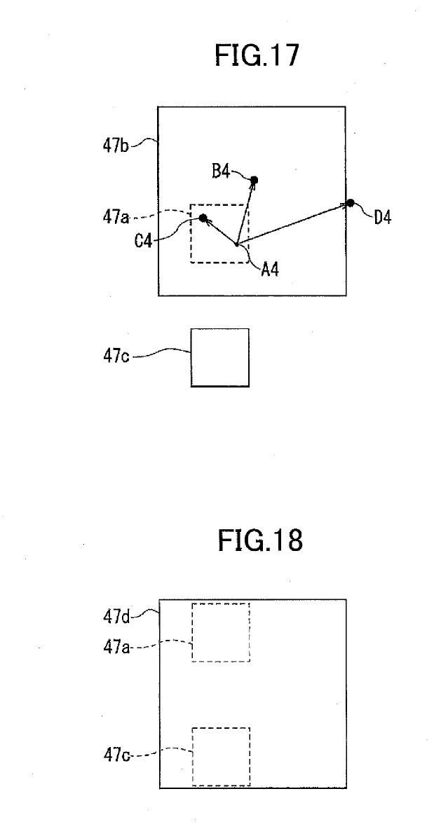

FIG. 17 is a schematic diagram for describing the user's maneuver performed during the gadget switch icon enlargement operation of FIG. 16. FIG. 18 is a schematic diagram for describing another user's maneuver performed during the gadget switch icon enlargement operation of FIG. 16. For the sake of convenience, only the gadget switch icon area 47 is illustrated in FIGS. 17 and 18, and the gadget switch icon 48 is omitted from FIGS. 17 and 18.

Because the processes performed in Steps 31 and 32 are substantially the same as those of Steps 21 and S22 of FIG. 14, description of the processes performed in Steps 31 and 32 are omitted.

In a case where the main control unit 30 determines that the tap maneuver is detected in Step S32, the main control unit 30 enlarges the gadget switch icon 48 subjected to the tap maneuver in Step S33. In Step S33, the main control unit 30 enlarges the gadget switch icon 48 for the purpose of, for example, facilitating visibility for the user. For example, as illustrated in FIG. 17, the main control unit 30 enlarges the size of the gadget switch icon area 47a to the size of a gadget icon area 47b and enlarges the gadget switch icon 48 in correspondence with the enlarged gadget icon area 47b.

In Step S34, the main control unit 30 determines whether a hold maneuver is detected. That is, the main control unit 30 determines whether the user's finger is detected as remaining in contact with the operation surface after the tap maneuver. A maneuver of the user may be determined as the hold maneuver regardless of the direction in which the user's finger is moved. In a case where the main control unit 30 determines that the hold maneuver is not detected (No in Step S34), the operation proceeds to a step of invalidating the process of enlarging the gadget switch icon 48 in Step S37.

In a case where the main control unit 30 determines that the hold maneuver is detected (Yes in Step S34), the main control unit 30 determines whether the position of the operation surface on which the hold maneuver is performed is within the gadget switch icon area 47 in Step S35. In a case where the main control unit 30 detects the hold maneuver is received within the gadget switch icon area 47 (Yes in Step S35), the gadget switch icon enlargement operation returns to Step S33 and repeats the processes performed on and after Step S33. For example, with reference to FIG. 17, in a case where a hold maneuver is detected in point B4 or point C4 located within the gadget switch icon area 47b on which the tap maneuver is performed, the main control unit 30 maintains the gadget switch icon area 47 in an enlarged state (i.e. the state of gadget switch icon area 47b in FIG. 17).

On the other hand, in a case where a hold maneuver is not detected within the gadget switch icon area 47b on which the tap maneuver is performed (No in Step S35), the main control unit 30 determines whether the position of the operation surface on which the hold maneuver is performed is located within another gadget switch icon area 47 (i.e. a gadget switch icon area 47 different from the gadget switch icon area 47 on which the tap maneuver is performed) in Step S36. In a case where the main control unit 30 determines that the hold maneuver is not received within the other gadget switch icon area 47 (No in Step S36), the main control unit 30 invalidates the process of enlarging the gadget switch icon 48 in Step S37. For example, with reference to FIG. 17, in a case where a hold maneuver is detected in point D4 located outside of the gadget switch icon area 47a on which the tap maneuver is performed and outside the other gadget switch icon area 47c, the main control unit 30 invalidates the process of enlarging of the gadget switch icon area 47 and the gadget switch icon 48 displayed therein.

On the other hand, in a case where the main control unit 30 determines that a hold maneuver is received within the other gadget switch icon area 47 (Yes in Step S36), the main control unit 30 enlarges the other gadget switch icon area 47 in which another gadget switch icon 48 is displayed in Step S38. For example, with reference to FIG. 18, the main control unit 30 enlarges the gadget switch icon area 47c to the gadget switch icon area 47d and enlarges the other gadget switch icon 48 in correspondence with the enlarged gadget switch icon area 47d.

In a case where the other gadget switch icon 48 is enlarged in Step S38, the gadget switch icon enlargement operation returns to Step 34 to repeat the processes performed on and after Step S34.

Next, an operation of performing slide display of icon display area images 62 (icon display area image slide display operation) according to an embodiment of the present invention is described.

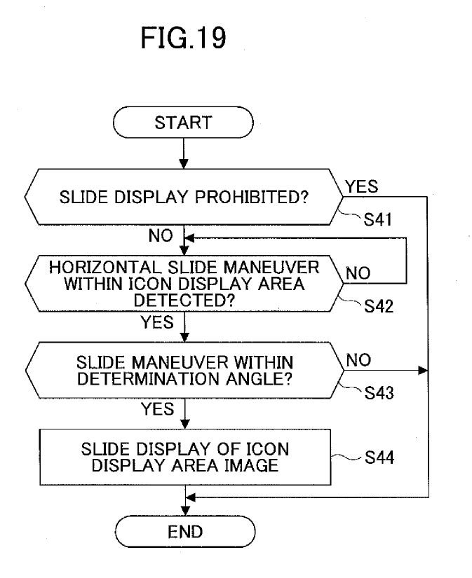

FIG. 19 is a flowchart for describing the icon display area image slide display operation performed by the main control unit 30 of the portable terminal 1 according to an embodiment of the present invention.

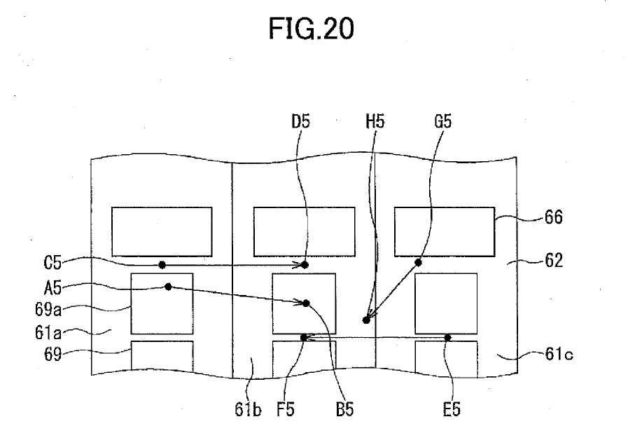

FIG. 20 is a schematic diagram for describing the user's maneuver performed during the icon display area image slide display operation of FIG. 19. For the sake of convenience, only the launcher icon area 66 and the thumbnail icon area 69 are illustrated in FIG. 20, and the launcher icon 65 and the thumbnail icon 68 are omitted from FIG. 20.

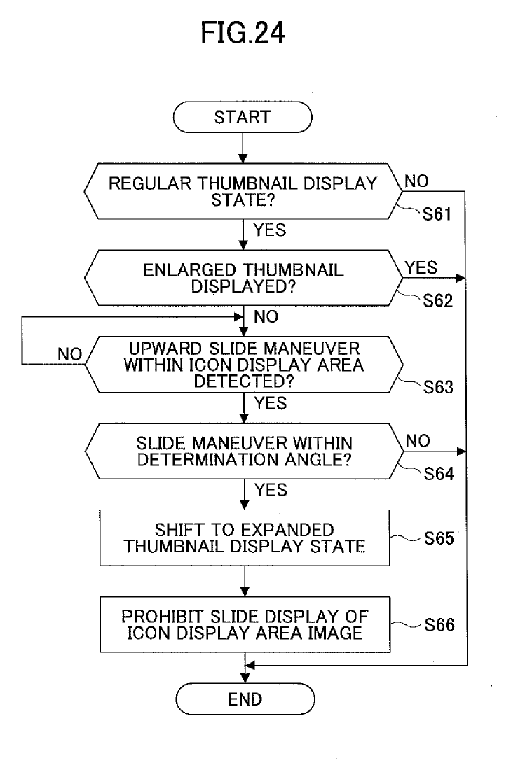

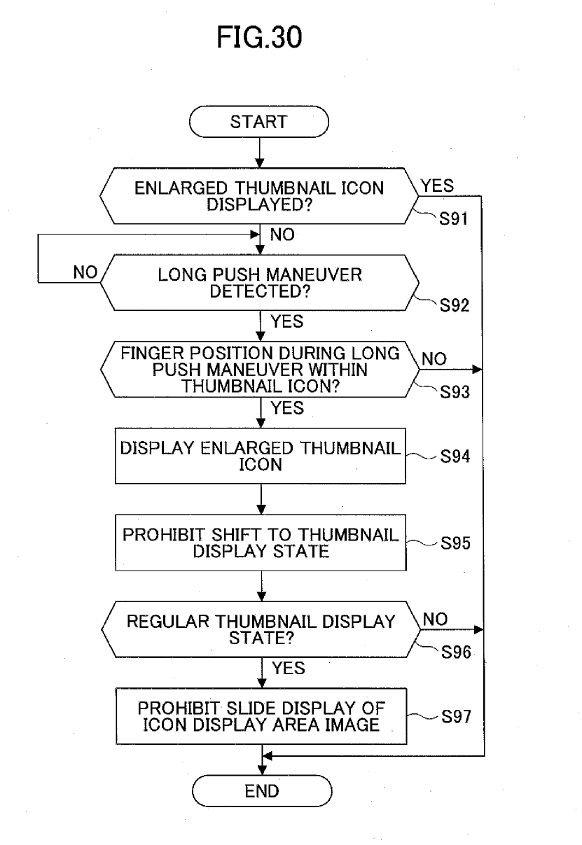

In Step S41, the main control unit 30 determines whether slide display of the icon display area images 62 is prohibited. The slide display of icon display area images 62 is performed by the below-described slide display prohibiting process in Step S66 of FIG. 24 and the below-described slide display prohibiting process in Step 97 of FIG. 30. The main control unit 30 terminates the icon display area image slide display operation in a case where the main control unit 30 determines that the slide display of the icon display area images 62 is prohibited.

On the other hand, in a case where the main control unit 30 determines that the slide display of icon display images 62 is not prohibited (No in Step S41), the main control unit 30 determines whether a slide maneuver or a flick maneuver (hereinafter collectively referred to as simply “slide maneuver”) is performed in a horizontal direction starting from a position (starting point) within the icon display area 61. In this embodiment, the term “within the icon display area 61” refers to an area excluding the gadget area 44, the gadget switch icon display area 46 and the launcher icon area 66. It is to be noted that the thumbnail icon area 69 is included in the icon display area 61. In a case where a slide maneuver starting from a position within the thumbnail icon area 69 is detected, the main control unit 30 determines that the slide maneuver is valid when the slide maneuver is directed toward an area different from the thumbnail icon area 69 from which the slide maneuver is started. In this embodiment, the horizontal direction corresponds to the left/right directions of FIG. 3. In a case where the main control unit 30 determines that no slide maneuver in the horizontal direction is detected, the main control unit 30 waits until detection of the slide maneuver in the horizontal direction.

On the other hand, in a case where the main control unit 30 determines that a slide maneuver in the horizontal direction is detected, the main control unit 30 determines whether the slide maneuver in the horizontal direction is within a predetermine angle (determination angle).

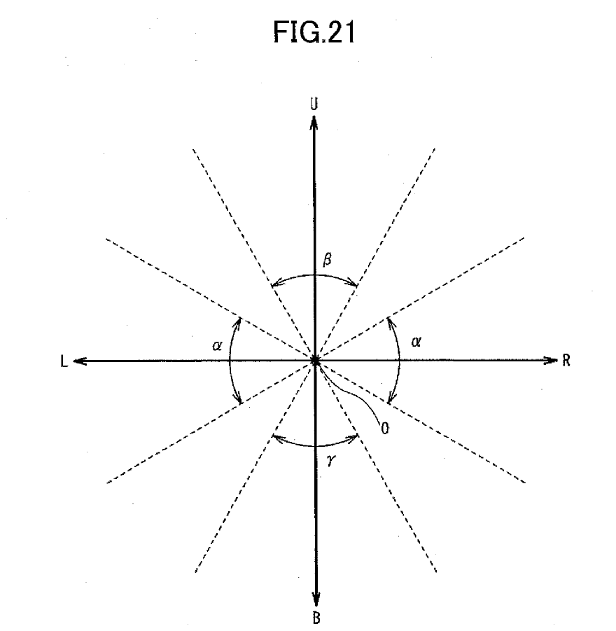

FIG. 21 is a schematic diagram for describing a determination angle for determining the validity of a slide maneuver according to an embodiment of the present invention.

In a case of determining the validity of a slide maneuver in the horizontal direction (directions L and R in FIG. 21), the main control unit 30 determines that the slide maneuver in the horizontal direction is valid when a contact object (e.g., finger) contacting the operation surface is moved within a determination angle of α degrees from a starting point O of the slide maneuver with respect to, for example, the horizontal directions L and R).

In a case where the main control unit 30 determines that the slide maneuver in the horizontal direction is within the determination angle (Yes in Step S43), the main control unit 30 perform the slide display of the icon display images 62 in Step S44. For example, with reference to FIG. 20, the main control unit 30 performs the slide display in a case where a slide maneuver from point A5 of a thumbnail area 69a to point B5 of another thumbnail area is detected, a case where a slide maneuver from a slide maneuver from point C5 of the icon display area 61a to point D5 of another icon display area 61b is detected, and a case where a slide maneuver from point E of an icon display area 61c to point F5 of another icon display area 61b.

On the other hand, in a case where the slide maneuver in the horizontal direction is determined to be beyond the determination angle, the main control unit 30 terminates the icon display area image slide display operation. For example, with reference to FIG. 20, the slide display is not performed in a case where the slide maneuver from point G5 to point H5 is detected because the slide maneuver is beyond the range of the determination angle.

Next, an operation performed in a case of receiving input with respect to a launcher icon 65 (launcher icon confirmation instruction reception operation) according to an embodiment of the present invention is described.

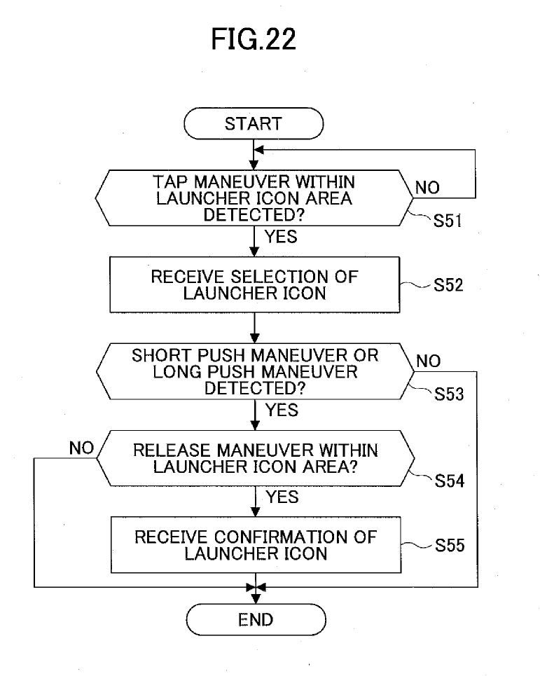

FIG. 22 is a flowchart for describing the launcher icon confirmation instruction reception operation performed by the main control unit 30 of the portable terminal 1 according to an embodiment of the present invention.

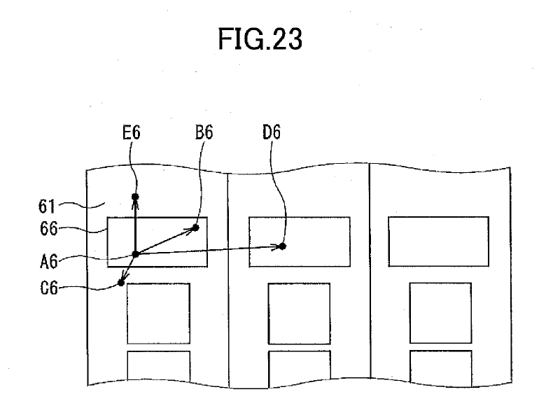

FIG. 23 is a schematic diagram for describing the user's maneuver performed during the launcher icon confirmation instruction reception operation of FIG. 22. For the sake of convenience, only the launcher icon area 66 is illustrated in FIG. 23, and the launcher icon 65 is omitted from FIG. 22.

In Step S51, the main control unit 30 determines whether a tap maneuver is detected within any of the launcher icon areas 66 by referring to a signal indicating input received by the input control unit 32. In a case where the main control unit 30 determines that no tap maneuver is detected within the launcher icon areas 66, the main control unit 30 waits (stands by) until detection of the tap maneuver.

On the other hand, in a case where a tap maneuver is detected within the launcher icon area 66, the main control unit 30 receives a selection with respect to the launcher icon 65 in accordance with the tap maneuver in Step S52.

Then, the main control unit 30 determines whether a short-push maneuver or a long-push maneuver is detected in Step S53. That is, the main control unit 30 determines whether a release maneuver is detected within a predetermined period after the detection of the tap maneuver or whether a release maneuver is not detected within a predetermined period after the detection of the tap maneuver. The main control unit 30 terminates the launcher icon confirmation instruction reception operation in a case where neither the short-push maneuver nor the long-push maneuver is detected.

On the other hand, in a case where the main control unit 30 determines that the short-push maneuver or the long-push maneuver is detected, the main control unit determines whether the position of the operation surface on which a release maneuver (accompanying the short-push maneuver or the long-push maneuver) is performed is within the launcher icon area 66 in Step S54. In determining the long-push maneuver, the main control unit 30 determines that the long-push maneuver is performed within the launcher icon area 66 on which the tap maneuver is performed in a case where the contact position of the finger detected upon the detection of the long-push maneuver is located within the launcher icon area 66. In a case where the main control unit 30 determines that the release maneuver is received within the launcher icon area 66 (Yes in Step S54), the main control unit 30 receives a confirmation instruction for executing a process assigned to the launcher icon 65 in Step S55. For example, with reference to FIG. 23, the main control unit 30 receives a confirmation instruction when receiving a tap maneuver at point A6 located within the launcher icon area 66 and receiving a release maneuver at point B6 located within the same launcher icon area 66 in which the tap maneuver is received.

On the other hand, in a case where the main control unit 30 determines that a release maneuver is not received within the launcher icon area 66 but instead outside the launcher icon area 66 (No in Step S54), the main control unit 30 terminates the launcher icon confirmation instruction reception operation without receiving a confirmation instruction. In this case, the main control unit 30 cancels the selection of the launcher icon 65 performed in Step S52 (i.e. receiving a selection instruction). For example, with reference to FIG. 23, in a case where the main control unit 30 determines that a release maneuver is received at point C6 (which is located outside the launcher icon area 66 on which a tap maneuver is performed), the main control unit 30 terminates the launcher icon confirmation instruction reception operation without receiving a confirmation instruction. In another example, the main control unit 30 cancels the selection of the launcher icon 65 without receiving a confirmation instruction in a case of detecting a slide maneuver from point A6 to point D6 located on the right of the point A6, or a case of detecting point E6 located on an upper part of FIG. 23.

Next, an operation performed in a case where the displaying of the thumbnail icons 68 is changed from the regular thumbnail display state to the expanded thumbnail display state according to an embodiment of the present invention is described.

FIG. 24 is a flowchart for describing a thumbnail icon status control operation performed in the regular thumbnail display state by the main control unit 30 of the portable terminal 1 according to an embodiment of the present invention.

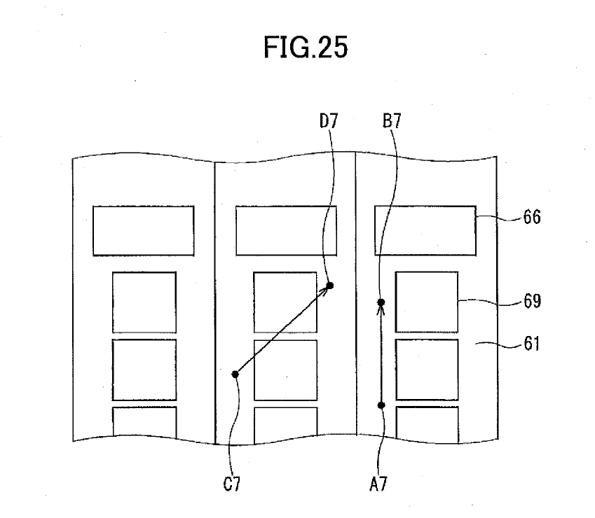

FIG. 25 is a schematic diagram for describing the user's maneuver performed during the thumbnail icon status control operation of FIG. 24. For the sake of convenience, only the launcher icon areas 66 and the thumbnail icon areas 69 are illustrated in FIG. 25, and the launcher icon 65 and the thumbnail icon 68 are omitted from FIG. 25.

In Step S61, the main control unit 30 determines whether the display state of the thumbnail icons 68 is a regular thumbnail display state. In a case where the display state of the thumbnail icons 68 is an expanded thumbnail display state and not the regular thumbnail display state (No in Step S61), the main control unit 30 terminates the thumbnail icon status control operation.

On the other hand, in a case where the main control unit 30 determines that the display state of the thumbnail icons 68 is a regular thumbnail display state (Yes in Step S61), the main control unit 30 determines whether the thumbnail icon area 69 is displayed in an enlarged state in Step S62. In a case where the main control unit 30 determines that an enlarged thumbnail area 69 is being displayed (Yes in Step S62), the user is assumed to be viewing the thumbnail icon 68 displayed in the regular thumbnail display state. Accordingly, in a case where a slide maneuver is detected in Step S63, the portable terminal 1 assumes that the slide maneuver detected in Step S63 is an inadvertent maneuver. Thereby, operability of the portable terminal 1 is improved. In a case where the thumbnail icon area 69 is displayed in an enlarged state, the main control unit prohibits shifting of the display state of the thumbnail icons 68 in the below-described Step 95 of FIG. 30.

In a case where the main control unit 30 determines that the thumbnail icon area 69 is not displayed in an enlarged state (No in Step S62), the main control unit 30 determines whether an upward slide maneuver or a flick maneuver (also collectively referred to as simply “slide maneuver”) starting from a position (starting point) within the icon display area 61 is detected in Step S63. In this embodiment, the term “within the icon display area 61” refers to an area excluding the gadget area 44, the gadget switch icon display area 46 and the launcher icon area 66. It is to be noted that the thumbnail icon area 69 is included in the icon display area 61. In a case where a slide maneuver starting from a position within the thumbnail icon area 69 is detected, the main control unit 30 determines that the slide maneuver is valid when the slide maneuver is directed toward an area different from the thumbnail icon area 69 from which the slide maneuver is started. In this embodiment, the direction “upward” corresponds to an upward direction in FIG. 3. In a case where the main control unit 30 determines that no upward slide maneuver is detected (No in Step S63), the main control unit 30 waits until detection of the upward slide maneuver.

On the other hand, in a case where the main control unit 30 determines that the upward slide maneuver is detected (Yes in Step S63), the main control unit 30 determines whether the upward slide maneuver is within a predetermined determination angle in Step S64.

With reference to FIG. 21, in a case of determining the validity of an upward (direction U in FIG. 21) slide maneuver, the main control unit 30 determines that the slide maneuver is valid in a case where a contact object (e.g., finger) contacting the operation surface is moved within a predetermined determination angle of β degrees from a starting point O of the slide maneuver with respect to, for example, a vertical direction U-B.

In a case where the main control unit 30 determines that the upward slide maneuver is within the predetermined determination angle of β degrees (Yes in Step S64), the main control unit 30 shifts the display state of the icon display area 61 (on which the upward slide maneuver is performed) from the regular thumbnail display state to the expanded thumbnail display state in Step S65. For example, with reference to FIG. 25, in a case where an upward slide maneuver from point A7 to B7 of the icon display area 61 is detected, the main control unit 30 shifts the display state of the icon display area 61 (on which the upward slide maneuver from point A7 to B7) is performed) from the regular thumbnail display state to the expanded thumbnail display state.

The main control unit 30 terminates the thumbnail icon status control operation in a case where the upward slide maneuver is determined to be beyond the predetermined determination angle. For example, with reference to FIG. 25, the display state of the thumbnail icons 68 is maintained as the regular thumbnail display state in a case where a slide maneuver from point C7 to point D7 in the icon display area 61 is detected.

Along with shifting the display state from the regular thumbnail display state to the expanded thumbnail display state, the main control unit 30 prohibits performing of slide display of the icon display area images 62 in Step S66 because thumbnail icons 68 (which were not displayed in the regular thumbnail display state) are displayed in the expanded thumbnail display state. In a state where all of the thumbnail icons 68 are displayed, it is assumed that the user is viewing the icon display area 61 displayed in the expanded thumbnail display state. Accordingly, in a case of detecting a slide maneuver for displaying the icon display area images 62 as described above with reference to FIG. 19, the main control unit 30 assumes that the detected slide maneuver is an inadvertent maneuver. Thereby, operability of the portable terminal 1 is improved.

Next, an operation performed in a case where the displaying of the thumbnail icons 68 is changed from the expanded thumbnail display state to the regular thumbnail display state according to an embodiment of the present invention is described.

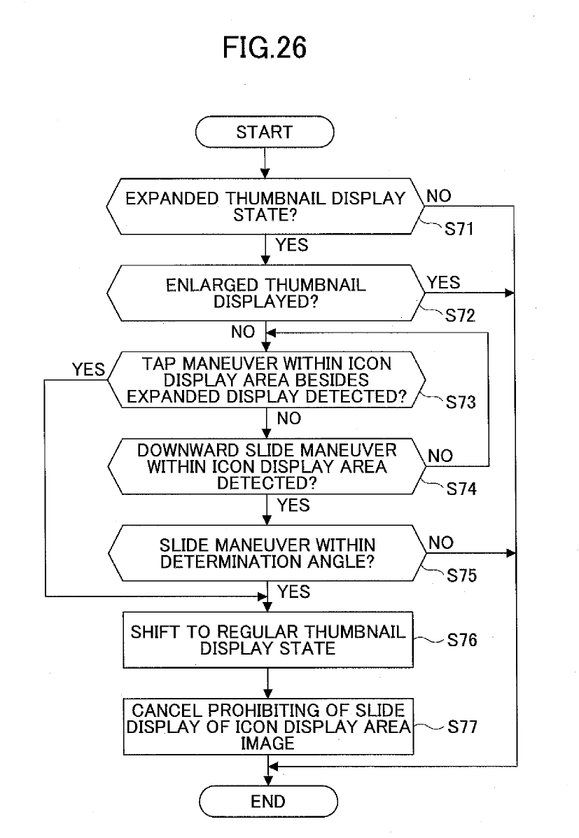

FIG. 26 is a flowchart for describing a thumbnail icon status control operation performed in the expanded thumbnail display state by the main control unit 30 of the portable terminal 1 according to an embodiment of the present invention.

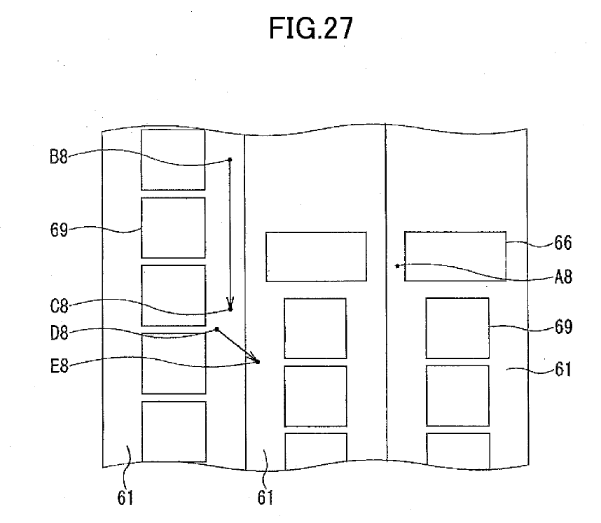

FIG. 27 is a schematic diagram for describing the user's maneuver performed during the thumbnail icon status control operation of FIG. 26. For the sake of convenience, only the launcher icon areas 66 and the thumbnail icon areas 69 are illustrated in FIG. 25, and the launcher icon 65 and the thumbnail icon 68 are omitted from FIG. 27.

In Step S71, the main control unit 30 determines whether the display state of the thumbnail icons 68 is an expanded thumbnail display state. In a case where the display state of the thumbnail icons 68 is a regular thumbnail display state and not the expanded thumbnail display state (No in Step S71), the main control unit 30 terminates the thumbnail icon status control operation.

On the other hand, in a case where the main control unit 30 determines that the display state of the thumbnail icons 68 is an expanded thumbnail display state (Yes in Step S71), the main control unit 30 determines whether the thumbnail icons 68 are displayed in an enlarged state in Step S72. In a case where the main control unit 30 determines that enlarged thumbnail icons 68 are being displayed (Yes in Step S72), the user is assumed to be viewing the thumbnail icons 68 displayed in the expanded thumbnail display state. Accordingly, in a case where a slide maneuver is detected in Steps S73 or S74, the portable terminal 1 assumes that the slide maneuver detected in Step S73 or S74 is an inadvertent maneuver. Thereby, operability of the portable terminal 1 is improved. In a case where the thumbnail icon area 69 is displayed in an enlarged state, the main control unit prohibits shifting of the display state of the thumbnail icons 68 in the below-described Step 95 of FIG. 30.

In a case where the main control unit 30 determines that the thumbnail icons 68 are not displayed in an enlarged state (No in Step S72), the main control unit 30 determines whether a tap maneuver is performed within another icon display area 61 being in a regular thumbnail display state (i.e. not in an expanded thumbnail display state) in Step S73. In a case where the main control unit 30 determines that a tap maneuver is performed within an icon display area 61 which is not in an expanded thumbnail display state (Yes in Step S73), the thumbnail icon status control operation proceeds to Step S76. For example, with reference to FIG. 27, in a case where a tap maneuver at point A8 within an icon display area 61 which is not in an expanded thumbnail display state, the main control unit 30 proceeds to the process of Step S76.

On the other hand, in a case where a tap maneuver is not performed on another icon display area 61 which is not in the expanded thumbnail display state (No in Step S73), the main control unit 30 determines whether a downward slide maneuver or a flick maneuver (also collectively referred to as simply “slide maneuver”) starting from a position (starting point) within the icon display area 61 being in an expanded thumbnail display state is detected in Step S73. In this embodiment, it is to be noted that the thumbnail icon area 69 is included in the icon display area 61. In a case where a slide maneuver starting from a position within the thumbnail icon area 69 is detected, the main control unit 30 determines that the slide maneuver is valid when the slide maneuver is directed toward an area different from the thumbnail icon area 69 from which the slide maneuver is started. In this embodiment, the direction “downward” corresponds to a downward direction in FIG. 7. In a case where the main control unit 30 determines that no downward slide maneuver is detected (No in Step S74), the main control unit 30 waits until detection of the downward slide maneuver.

On the other hand, in a case where the main control unit 30 determines that the downward slide maneuver is detected (Yes in Step S74), the main control unit 30 determines whether the downward slide maneuver is within a predetermined determination angle in Step S75.

With reference to FIG. 21, in a case of determining the validity of a downward (direction B in FIG. 21) slide maneuver, the main control unit 30 determines that the slide maneuver is valid in a case where a contact object (e.g., finger) contacting the operation surface is moved within a predetermined determination angle of γ degrees from a starting point O of the slide maneuver with respect to, for example, a vertical direction U-B.

In a case where the main control unit 30 determines that the downward slide maneuver is within the predetermined determination angle of γ degrees (Yes in Step S75), the main control unit 30 shifts the display state of the icon display area 61 (on which the downward slide maneuver is performed) from the expanded thumbnail display state to the regular thumbnail display state in Step S76. For example, with reference to FIG. 27, in a case where a downward slide maneuver from point B8 to C8 of the icon display area 61 is detected, the main control unit 30 shifts the display state of the icon display area 61 (on which the downward slide maneuver from point A7 to B7) is performed) from the expanded thumbnail display state to the regular thumbnail display state.

The main control unit 30 terminates the thumbnail icon status control operation in a case where the downward slide maneuver is determined to be beyond the predetermined determination angle. For example, with reference to FIG. 27, the display state of the thumbnail icons 68 is maintained as the expanded thumbnail display state in a case where a slide maneuver from point D8 to point E8 in the icon display area 61 is detected.

Along with shifting the display state from the expanded thumbnail display state to the regular thumbnail display state, the main control unit 30 cancels the prohibiting of slide display of the icon display area images 62 in Step S77.

Next, an operation performed in a case of receiving input with respect to a thumbnail icon 68 (thumbnail icon confirmation instruction reception operation) according to an embodiment of the present invention is described.

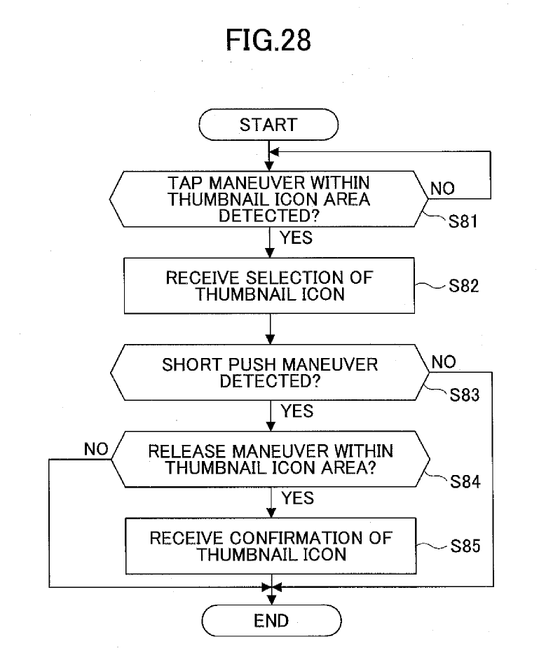

FIG. 28 is a flowchart for describing the thumbnail icon confirmation icon confirmation instruction reception operation performed by the main control unit 30 of the portable terminal 1 according to an embodiment of the present invention.

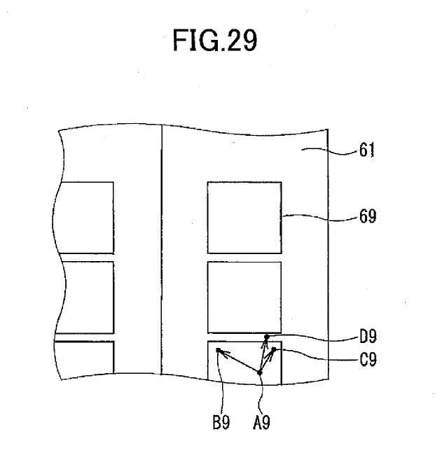

FIG. 29 is a schematic diagram for describing the user's maneuver performed during the thumbnail icon confirmation instruction reception operation of FIG. 28. For the sake of convenience, only the thumbnail icon area 69 is illustrated in FIG. 29, and the thumbnail icon 68 is omitted from FIG. 29.

In Step S81, the main control unit 30 determines whether a tap maneuver is detected within any of the thumbnail icon areas by referring to a signal indicating input received by the input control unit 32. It is to be noted that, although a tap maneuver is detected from all of the thumbnail icon areas 69 in a case where the thumbnail display state is a regular thumbnail display state, detection of a tap maneuver is determined only for a thumbnail icon area 69 of an icon display area 61 being in an expanded thumbnail display state in Step 81. Thus, the tap maneuver performed on the thumbnail icon area 69 of the icon display area 61 being in an expanded thumbnail display state is recognized as the tap maneuver in Step S81 of FIG. 28. In a case where the main control unit 30 determines that no tap maneuver is detected within the thumbnail icon area 69, the main control unit 30 waits (stands by) until detection of the tap maneuver.

On the other hand, in a case where a tap maneuver is detected within the thumbnail icon area 69, the main control unit 30 receives a selection with respect to the thumbnail icon 68 in the tap maneuver in Step S82.

Then, the main control unit 30 determines whether a short-push maneuver is detected in Step S83. That is, the main control unit 30 determines whether a release maneuver is detected within a predetermined period after the detection of the tap maneuver. The main control unit 30 terminates the thumbnail icon confirmation instruction reception operation in a case where the short-push maneuver is not detected.

On the other hand, in a case where the main control unit 30 determines that the short-push maneuver is detected, the main control unit determines whether the position of the operation surface on which a release maneuver (accompanying the short-push maneuver) is performed is within the thumbnail icon area 69 in Step S84. In a case where the main control unit 30 determines that the release maneuver is received within the thumbnail icon area 69 (Yes in Step S84), the main control unit 30 receives a confirmation instruction for executing a process assigned to the thumbnail icon 68 in Step S85. For example, with reference to FIG. 29, the main control unit 30 receives a confirmation instruction when receiving a tap maneuver at point A9 located within the thumbnail icon area 69 and then receiving a release maneuver at point B9 or point C9 located within the same thumbnail icon area 69 in which the tap maneuver is received.

On the other hand, in a case where the main control unit 30 determines that a release maneuver is not received within the thumbnail icon area 69 but instead outside the thumbnail icon area 69 (No in Step S84), the main control unit 30 terminates the thumbnail icon confirmation instruction reception operation without receiving a confirmation instruction. In this case, the main control unit 30 cancels the selection of the thumbnail icon 68 performed in Step S82 (i.e. receiving a selection instruction). For example, with reference to FIG. 29, in a case where the main control unit 30 determines that a release maneuver is received at point D9 (which is located outside the thumbnail icon area 69 on which a tap maneuver is performed), the main control unit 30 terminates the thumbnail icon confirmation instruction reception operation without receiving a confirmation instruction.

Next, there is described an operation performed in a case of enlarging a displayed thumbnail icon 68 during a regular thumbnail display state according to an embodiment of the present invention.

FIG. 30 is a flowchart for describing a thumbnail icon enlargement operation performed in the regular thumbnail display state by the main control unit 30 of the portable terminal 1 according to an embodiment of the present invention.

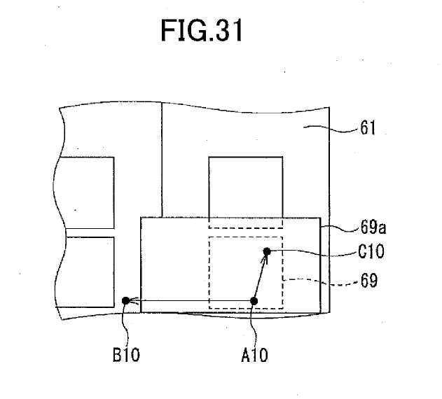

FIG. 31 is a schematic diagram for describing the user's maneuver performed during the thumbnail icon enlargement operation of FIG. 30. For the sake of convenience, only the thumbnail icon areas 69 are illustrated in FIG. 31, and the thumbnail icons 68 are omitted from FIG. 31.

The main control unit 30 determines whether the thumbnail icon area 69 is displayed in an enlarged state in Step S91. In a case where the main control unit 30 determines that an enlarged thumbnail icon area 69 is being displayed (Yes in Step S91), the main control unit 30 terminates the thumbnail icon enlargement operation.

On the other hand, in a case where the main control unit 30 determines that the thumbnail icon area 69 is not being displayed in an enlarged state (No in Step S91), the main control unit 30 determines whether a long-push maneuver is performed on any of the thumbnail icon areas 69 in Step S92. In a case where a long-push maneuver to the thumbnail icon area 69 is not detected, the main control unit 30 waits until detection of the long-push maneuver. It is to be noted that, although a long-push maneuver is detected from all of the thumbnail icon areas 69 in a case where the thumbnail display state is a regular thumbnail display state, detection of a long-push maneuver is determined only for a thumbnail icon area 69 of an icon display area 61 being in an expanded thumbnail display state. Thus, the long-push maneuver performed on the thumbnail icon area 69 of the icon display area 61 being in an expanded thumbnail display state is recognized as the long-push maneuver in Step S92 of FIG. 30.

On the other hand, in a case where the main control unit 30 determines that a long-push maneuver is detected (Yes in Step S92), the main control unit 30 determines whether the position of the operation surface on which a tap maneuver (accompanying the long-push maneuver) is performed is within the thumbnail icon area 69 in Step S93. In a case where the main control unit 30 determines that a tap maneuver is not received within the thumbnail icon area 69 but within another thumbnail icon area (No in Step S93), the main control unit 30 terminates the thumbnail icon enlargement operation. For example, with reference to FIG. 31, in a case where the main control unit 30 determines that a long-push maneuver is received at point A10 (which is located within the thumbnail icon area 69 on which a tap maneuver is performed), the main control unit 30 terminates the thumbnail icon enlargement operation when finger contact of the long-push maneuver on the operation surface is detected at point B10 (which is located outside the thumbnail icon area 69 including the point A10 on which a tap maneuver is performed).

On the other hand, in a case where the main control unit 30 determines that finger contact of the long-push maneuver is detected within the thumbnail icon area 69 on which a tap maneuver accompanying the long-push maneuver is performed, the main control unit 30 enlarges the thumbnail icon area 69 receiving the long-push maneuver in Step S94. Further, the thumbnail icon 68 is also enlarged in correspondence with the enlarging of the corresponding thumbnail icon area 69. For example, with reference to FIG. 31, when a long-push maneuver is detected at point A10 after performing a tap maneuver at point A10, the thumbnail icon area 69 is enlarged to a thumbnail icon area 69a when finger contact is detected at point C10 located within the thumbnail icon area 69 including point A10.

In Step S95, the main control unit 30 prohibits shifting between the regular thumbnail display state and the expanded thumbnail display state. That is, in a case where the thumbnail display state is currently the regular thumbnail display state, the main control unit 30 prohibits shifting to the expanded thumbnail display state. In a case where the thumbnail display state is currently the expanded thumbnail display state, the main control unit 30 prohibits shifting to the regular thumbnail display state. In a case where the thumbnail icon area 69 is enlarged, the user is assumed to be viewing the thumbnail icon area 69 displayed in an enlarged state. Accordingly, in a case where a slide maneuver is detected, the portable terminal 1 assumes that the detected slide maneuver is an inadvertent maneuver. Thereby, operability of the portable terminal 1 is improved.

Next, there is described an operation performed in a case where thumbnail icons 68 are enlarged during a regular thumbnail display state according to an embodiment of the present invention.

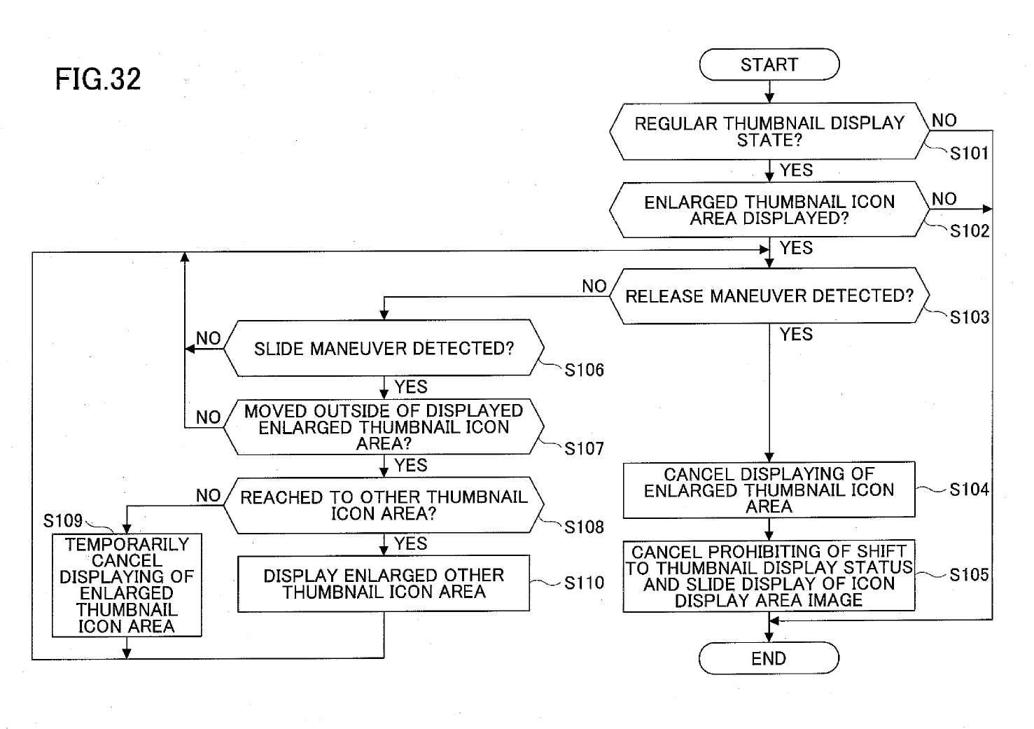

FIG. 32 is a flowchart for describing an operation performed by the main control unit 30 of the portable terminal 1 in a case where thumbnail icons 68 are displayed in an enlarged state during a regular thumbnail display state according to an embodiment of the present invention.

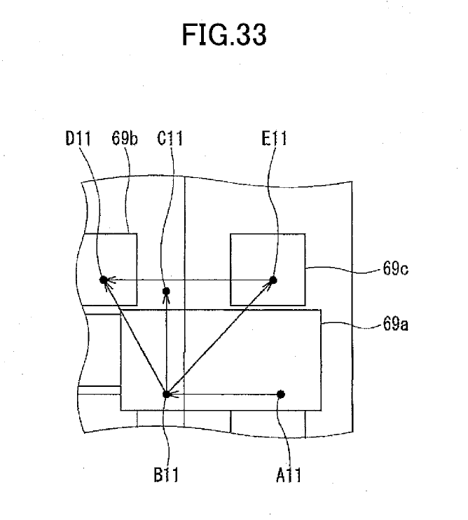

FIG. 33 is a schematic diagram for describing the user's maneuver performed during the thumbnail icon enlargement operation of FIG. 32. For the sake of convenience, only the thumbnail icon areas 69 are illustrated in FIG. 33, and the thumbnail icons 68 are omitted from FIG. 33.

In Step S101, the main control unit 30 determines whether the thumbnail display state is a regular thumbnail display state. In a case where the main control unit 30 determines that the thumbnail display state is an expanded thumbnail display state and not the regular thumbnail display state (No in Step S101), the main control unit 30 terminates the thumbnail icon enlargement operation.

On the other hand, in a case where the main control unit 30 determines that the thumbnail display state is the regular thumbnail display state (Yes in Step S101), the main control unit 30 determines whether the thumbnail icon display area 69 is being displayed in an enlarged state in Step S102. In this embodiment, a case where the thumbnail icon display area 69 is being displayed in an enlarged state (Yes in Step S102) is a state where the thumbnail icon enlargement operation of FIG. 30 is executed and one of the thumbnail icon display areas 69 is being displayed in an enlarged state. In a case where the thumbnail icon area 69 is not displayed in an enlarged state (No in Step S102), the main control unit 30 terminates the operation of FIG. 32.

On the other hand, in a case where the main control unit 30 determines that the thumbnail icon area 69 is displayed in an enlarged state (Yes in Step S102), the main control unit 30 determines whether a release maneuver is detected in Step S103. In a case where the main control unit 30 determines that the release maneuver is detected (Yes in Step S103), the main control unit 30 cancels the displaying of the enlarged thumbnail icon area 69 in Step S104.

Then, the main control unit 30 cancels the prohibiting of shifting the thumbnail display state of Step S95 and the prohibiting of slide display of icon display area images 62 of Step S97 in the icon enlargement operation of FIG. 31.

On the other hand, in a case where the release maneuver is not detected (No in Step S103), the main control unit 30 determines whether a slide maneuver is detected in Step S106. In a case where the main control unit 30 determines that the slide display is not detected (No in Step S106), the main control unit 30 repeats the processes performed on and after Step S103.

On the other hand, in a case where the slide maneuver is detected (Yes in Step S106), the main control unit 30 determines whether the finger of the slide maneuver is moved to an area outside the enlarged thumbnail icon area 69 in Step S107. In a case where the main control unit 30 determines that the finger of the slide maneuver is not moved to an area outside the enlarged thumbnail icon area 69 (No in Step S107), the main control unit 30 repeats the processes performed on and after Step S103. For example, with reference to FIG. 33, the thumbnail icon area 69a is maintained at an enlarged state in a case where the slide maneuver from point A11 located within the thumbnail icon area 69a to point B1 located within the thumbnail icon area 69a because the finger of the slide maneuver is not moved outside the thumbnail icon area 69a.

On the other hand, in a case where the main control unit 30 determines that the finger of the slide maneuver is moved outside the thumbnail icon area 69 (Yes in Step S107), the main control unit 30 determines whether the finger of the slide maneuver has reached another thumbnail icon display area 69 in Step S108. At this step, the user's finger is still contacting the operation surface after the thumbnail icon area 69 is enlarged. In a case where the main control unit 30 determines that the finger of the slide maneuver has not reached the other thumbnail icon display area 69 (No in Step S108), the main control unit 30 temporarily cancels displaying of the enlarged thumbnail icon (Step S109). That is, although the user's finger is remaining on the operation surface after the thumbnail icon area 69 is enlarged, no thumbnail icon area 69 is displayed in an enlarged state in Step S109. After the temporary cancelling of the display of the enlarged thumbnail icon area 69, the main control unit 30 repeats the processes performed on and after Step S103. For example, with reference to FIG. 33, the display of the enlarged thumbnail icon area 69 is temporarily cancelled in a case where a slide maneuver is performed from point A11 located within the enlarged thumbnail icon area 69a to point C11 located outside of the enlarged thumbnail icon area 69a.

On the other hand, in a case where the main control unit 30 determines that the finger of the slide maneuver has reached the other thumbnail icon area 69, the main control unit 30 displays the other thumbnail icon area 69 in an enlarged state. For example, with reference to FIG. 33, the portable terminal 1 switches the thumbnail icon area to be enlarged from the thumbnail icon area 69a to another thumbnail icon area 69b in a case of detecting a slide maneuver from point B11 located within the enlarged thumbnail icon display area 69a to point D1 located within the other thumbnail icon area 69b. In another example, with reference to FIG. 33, the portable terminal 1 switches the thumbnail icon area to be enlarged from the thumbnail icon area 69a to another thumbnail icon area 69c and then to the other thumbnail icon area 69b in a case of detecting a slide maneuver from point B11 located within the thumbnail icon area 69a to point D11 located within the other thumbnail icon area 69b via point E11 located within the other thumbnail icon area 69c. In a case where the finger of the slide maneuver is not located in any of the thumbnail icon areas 69, the main control unit 30 temporarily cancels the enlarged display of the thumbnail icon areas 69. For example, with reference to FIG. 33, in a case where the finger of the slide maneuver is moved from point B11 to point D11, the finger of the slide maneuver is located neither in the thumbnail icon area 69a nor the thumbnail icon area 69b.

After Step S110, the portable terminal 1 repeats the processes performed on and after the Step S103.

Next, there is described an operation performed in a case where thumbnail icons 68 are enlarged during an expanded thumbnail display state according to an embodiment of the present invention.

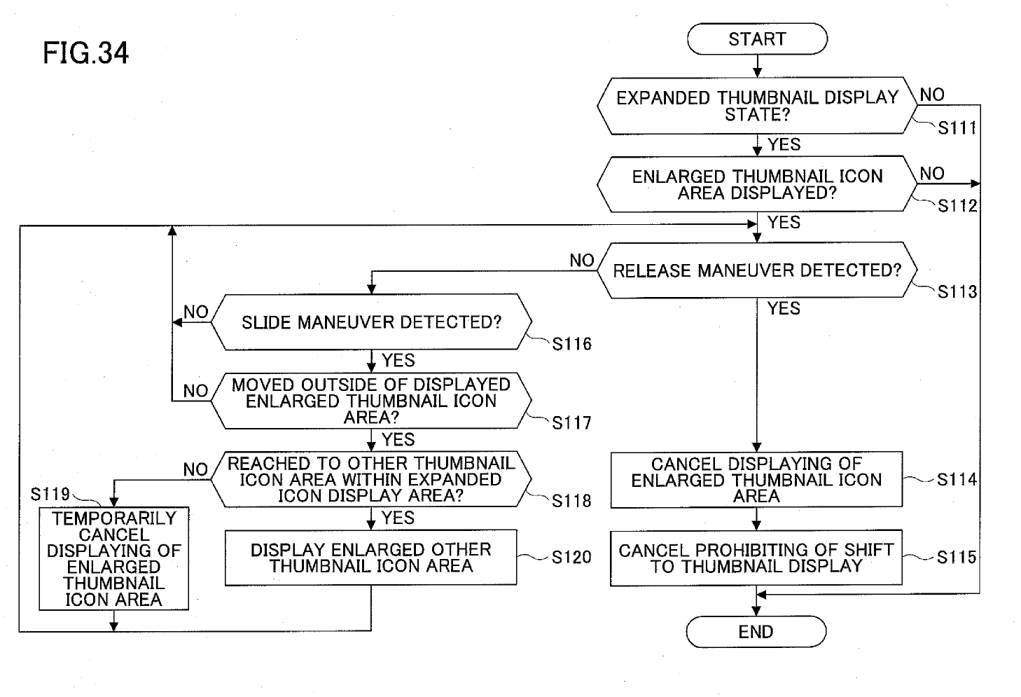

FIG. 34 is a flowchart for describing an operation performed by the main control unit 30 of the portable terminal 1 in a case where thumbnail icons 68 are displayed in an enlarged state during an expanded thumbnail display state according to an embodiment of the present invention.

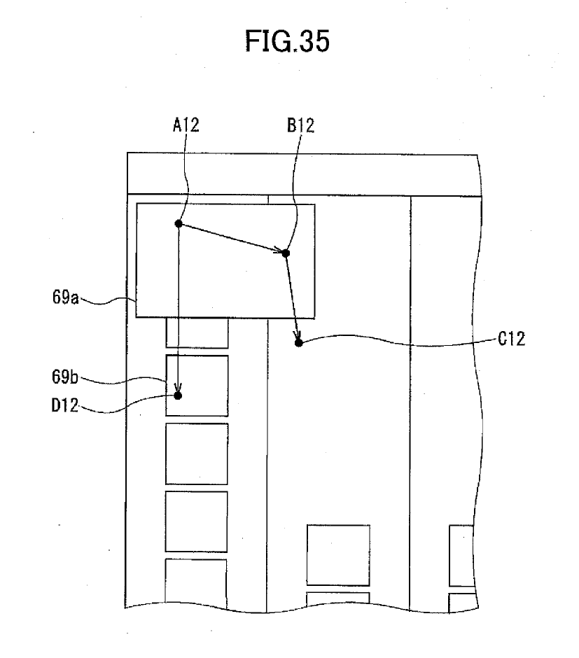

FIG. 35 is a schematic diagram for describing the user's maneuver performed during the thumbnail icon enlargement operation of FIG. 34. For the sake of convenience, only the thumbnail icon areas 69 are illustrated in FIG. 35, and the thumbnail icons 68 are omitted from FIG. 35.

In Step S111, the main control unit 30 determines whether the thumbnail display state is an expanded thumbnail display state. Because the processes performed in Steps 112-S114 of FIG. 34 are substantially the same as the processes performed in Steps S102-S104 of FIG. 32, the processes performed in Steps 112-S114 of FIG. 34 are not further described.

In Step S115, the main control unit 30 cancels the process of prohibiting the shifting of thumbnail displays states of Step S95 of FIG. 30.

On the other hand, in a case where a release maneuver is not detected in Step S113, the main control unit 30 determines whether a slide maneuver is detected in Step S116. In a case where the main control unit 30 determines that the slide maneuver is not detected (No in Step S116), the main control unit 30 repeats the processes performed on and after Step S113.

On the other hand, in a case where the slide maneuver is detected (Yes in Step S116), the main control unit 30 determines whether the finger of the slide maneuver is moved to an area outside the enlarged thumbnail icon area 69 in Step S117. In a case where the main control unit 30 determines that the finger of the slide maneuver is not moved to an area outside the enlarged thumbnail icon area 69 (No in Step S117), the main control unit 30 repeats the processes performed on and after Step S113. For example, with reference to FIG. 35, the thumbnail icon area 69a is maintained at an enlarged state in a case where the slide maneuver from point A12 located within the thumbnail icon area 69a to point B1 located within the thumbnail icon area 69a because the finger of the slide maneuver is not moved outside the thumbnail icon area 69a.

On the other hand, in a case where the main control unit 30 determines that the finger of the slide maneuver is moved outside the thumbnail icon area 69 (Yes in Step S117), the main control unit 30 determines whether the finger of the slide maneuver has reached another thumbnail icon display area 69 located within an icon display area 61 being in an expanded state in Step S118. At this step, the user's finger is still contacting the operation surface after the thumbnail icon area 69 is enlarged. In a case where the main control unit 30 determines that the finger of the slide maneuver has not reached the other thumbnail icon display area 69 (No in Step S118), the main control unit 30 temporarily cancels displaying of the enlarged thumbnail icon (Step S119). That is, although the user's finger is remaining on the operation surface after the thumbnail icon area 69 is enlarged, no thumbnail icon area 69 is displayed in an enlarged state in Step S119. After the temporary cancelling of the display of the enlarged thumbnail icon area 69, the main control unit 30 repeats the processes performed on and after Step S113. For example, with reference to FIG. 35, the display of the enlarged thumbnail icon area 69 is temporarily cancelled in a case where a slide maneuver is performed from point B12 located within the enlarged thumbnail icon area 69a to point C12 located outside of the enlarged thumbnail icon area 69a. By the temporary cancelling of the display of enlarged thumbnail icon areas 69, none of the thumbnail icon areas 69 are displayed in an enlarged state.

On the other hand, in a case where the main control unit 30 determines that the finger of the slide maneuver has reached the other thumbnail icon area 69, the main control unit 30 switches the thumbnail icon area to be enlarged from a currently enlarged thumbnail icon area 69 to the other thumbnail icon area 69 in Step S120. For example, with reference to FIG. 35, the main control unit 30 of the portable terminal 1 switches the thumbnail icon area to be enlarged from the thumbnail icon area 69a to another thumbnail icon area 69b in a case of detecting a slide maneuver from point A12 located within the currently enlarged thumbnail icon display area 69a to point D12 located within the other thumbnail icon area 69b. After Step S120, the main control unit 30 of the portable terminal 1 repeats the processes performed on and after Step S113. It is to be noted that, in a case of performing a thumbnail icon enlargement operation during the expanded thumbnail display state, the displaying of an enlarged thumbnail icon area 69 is temporarily cancelled in a case where the slide maneuver is performed in none of the thumbnail icon areas 69.

Hence, with the portable terminal 1 according to the above-described embodiment of the present invention, the user can intuitively maneuver the portable terminal 1 and satisfactorily recognize operation status (maneuver status) of the portable terminal 1. For example, owing to the slide display of icon display area images 62, the portable terminal 1 not only provides excellent operability but also provides an inventive user interface enabling intuitive maneuvers to be performed therewith.

Furthermore, according to the above-described embodiment of the present invention, the portable terminal 1 prohibits slide display of the icon display area images 62 during the expanded thumbnail display state or during the display of the thumbnail icon area 69 in an enlarged state. Furthermore, according to the above-described embodiment of the present invention, the portable terminal 1 prohibits shifting between the regular thumbnail display state and the expanded thumbnail display state during the display of the thumbnail icon area 69 in an enlarged state. Accordingly, in addition to enabling intuitive maneuvers, the portable terminal 1 can prevent an unnecessary display of, for example, an icon due to an inadvertent maneuver by the user.

The portable terminal 1 according to the above-described embodiment of the present invention may be, for example, a portable telephone, a PDA (Personal Digital Assistant), a portable music player, a portable movie player, and the like.

Although the series of processes performed in the above-described embodiment of the present invention can be executed with software, the series of processes performed in the above-described embodiment of the present invention can also be executed with hardware.

Although the steps in the flowcharts according to the above-described embodiment of the present invention are performed in chronological order, the order of performing the steps in the flowcharts is not limited to chronological order. For example, a part of the steps in the flowcharts may be performed serially or performed independently.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A portable terminal comprising:
a storage unit that stores a plurality of icons and a plurality of icon display area images corresponding to the plural icons;
a display unit that displays a predetermined number of target icon display area images among the plural icon display area images together with target icons corresponding to the target icon display area images, the target icon display area images being arranged in a first direction;
an input unit that receives an instruction by detecting movement of a contact object contacting an operation surface of the display unit; and
a control unit that moves the target icon display area images in a second direction while rotating the target icon display area images around corresponding axes extending along the target icon display area images in a case where the input unit detects the contact object being moved in a direction opposite to the first direction;
wherein the corresponding axes are substantially perpendicular to the second direction.

2. The portable terminal as claimed in claim 1,
wherein the storage unit is configured to store the plural icons including upper level icons and lower level icons corresponding to the upper level icons,
wherein the display unit is configured to display a first number of the lower level icons inside one of the target icon display area images that displays one of the upper level icons, and
wherein the first number of the lower level icons are arranged in a direction different from the second direction.

3. The portable terminal as claimed in claim 2,
wherein the display unit is configured to display a second number of the lower level icons inside the one of the target icon display area images that displays the one of the upper level icons in a case where the input unit detects the contact object being moved in a direction in which the lower level icons are arranged in a state where the contact object is contacting the one of the target icon display area images displayed on the operation surface, and
wherein the second number of the lower level icons is a larger value than the first number of the lower level icons.

4. The portable terminal as claimed in claim 3, wherein the control unit is configured to prohibit the icon display area images from being moved in the second direction in a case where the display unit displays the second number of the lower level icons.

5. The portable terminal as claimed in claim 3, wherein the display part is configured to display the first number of the lower level icons in a case where the input unit detects a predetermined maneuver after the second number of the lower level icons are displayed.

6. The portable terminal as claimed in claim 2, wherein the display unit is configured to display one of the lower level icons in an enlarged state in a case where the input unit detects the contact object contacting the one of the lower level icons for a predetermined time.

7. The portable terminal as claimed in claim 5, wherein the display unit is configured to display one of the first number of the lower level icons in an enlarged state in a case where a predetermined time elapses in the state where the contact object is contacting the one of the target icon display area images displayed on the operation surface.

8. The portable terminal as claimed in claim 7,
wherein the control unit is configured to prohibit the display part from displaying the first number of the lower level icons after displaying the second number of the lower level icons in a case of displaying the one of the first number of the lower level icons in an enlarged state, and
wherein the control unit is configured to prohibit the display part from displaying the second number of the lower level icons after displaying the first number of the lower level icons in a case of displaying the one of the first number of the lower level icons.

9. The portable terminal as claimed in claim 6, wherein the control part is configured to prohibit the icon display area images from being moved in the second direction in a case of displaying the one of the lower level icons in the enlarged state.

10. The portable terminal as claimed in claim 1, wherein the control part is configured to rotate the target icon display area images 180 degrees around the corresponding axes whenever the target icon display area images are moved in the second direction.
